(19) United States
(12) Patent Application Publication
(10) Pub. No.: US 2015/0036758 A1
(43) Pub. Date: Feb. 5, 2015

(54) IMAGE PROCESSING APPARATUS AND IMAGE PROCESSING METHOD

(71) Applicant: SONY CORPORATION, Tokyo (JP)

(72) Inventor: Kazushi Sato, Kanagawa (JP)

(21) Appl. No.: 14/232,017

(22) PCT Filed: May 24, 2012
(86) PCT No.: PCT/JP2012/063309

§ 371 Date: Feb. 21, 2014

(30) Foreign Application Priority Data
Jul. 19, 2011 (JP) 2011-158027

(51) Int. Cl. H04N 19/30; H04N 19/117; H04N 19/46; H04N 19/187

(52) U.S. Cl. CPC H04N 19/00424; H04N 19/00321; H04N 19/00066; H04N 19/00545
USPC 375/240.29

(57) ABSTRACT

Provided is an image processing apparatus including a decoding section that decodes quad-tree information identifying a first quad-tree set to a first layer of a scalable-video-decoded image containing the first layer and a second layer higher than the first layer, and a setting section that sets a second quad-tree to the second layer using the quad-tree information decoded by the decoding section.

### TECHNICAL FIELD

The present disclosure relates to an image processing apparatus and an image processing method.

### BACKGROUND ART

Compression technology like the H.26x (ITU-T Q6/16 VCEG) standard and MPEG (Moving Picture Experts Group)-y standard that compresses the amount of information of images using redundancy specific to images have widely been used for the purpose of efficiently transmitting or accumulating digital images. In Joint Model of Enhanced-Compression Video Coding as part of activity of MPEG4, international standards called H.264 and MPEG-4 Part10 (Advanced Video Coding; AVC) capable of realizing a higher compression rate by incorporating new functions based on the H.26x standard have been laid down.

In H.264/AVC, each of macro blocks that can be arranged like a grid inside an image is the basic processing unit of encoding and decoding of the image. In HEVC (High Efficiency Video Coding) whose standardization is under way as the next-generation image encoding method, by contrast, a coding unit (CU) arranged in a quad-tree shape inside an image becomes the basic processing unit of encoding and decoding of the image (see Non-Patent Literature 1). Thus, an encoded stream encoded by an encoder conforming to HEVC has quad-tree information to identify a quad-tree set inside the image. Then, a decoder uses the quad-tree information to set a quad-tree like the quad-tree set by the encoder in the image to be decoded.

In HEVC, in addition to the CU, various processes are performed in blocks arranged in a quad-tree shape as processing units. For example, Non-Patent Literature 2 shown below proposes to decide the filter coefficient of an adaptive loop filter (ALF) and perform filtering based on a block using the blocks arranged in a quad-tree shape. Also, Non-Patent Literature 3 shown below proposes to perform an adaptive offset (AO) process based on a block using the blocks arranged in a quad-tree shape.

### CITATION LIST

### Non-Patent Literature

Non-Patent Literature 1: JCTUC-E603, “WD3: Working High-Efficiency Video Coding”, T. Wiegand, et al, July, 2010

Non-Patent Literature 2: VCEG-AI18, “Block-based Adaptive Loop Filter”, Takeshi Chujoh, et al, July, 2008

Non-Patent Literature 3: JCTUC-D122, “CE8 Subtest 3: Picture Quality Adaptive Offset”, C.-M. Fu, et al. January, 2011

### SUMMARY OF INVENTION

### Technical Problem

However, the amount of code needed for quad-tree information is not small. Particularly when scalable video coding (SVC) is performed, sufficient encoding efficiency may not be obtained from encoding of redundant quad-tree information. The scalable video coding is a technology of hierarchically encoding a layer that transmits a rough image signal and a layer that transmits a fine image signal. When the scalable video coding is performed, it is necessary for both of an encoder and a decoder to set equivalent quad-trees in each of a plurality of layers.

Therefore, it is desirable that a mechanism capable of efficiently encoding and decoding quad-tree information be provided for scalable video coding.

### Solution to Problem

According to an embodiment of the present disclosure, there is provided an image processing apparatus including a decoding section that decodes quad-tree information identifying a first quad-tree set to a first layer of a scalable-video-decoded image containing the first layer and a second layer higher than the first layer, and a setting section that sets a second quad-tree to the second layer using the quad-tree information decoded by the decoding section.

The image processing device mentioned above may be typically realized as an image decoding device that decodes an image.

According to an embodiment of the present disclosure, there is provided an image processing method including decoding quad-tree information identifying a first quad-tree set to a first layer of a scalable-video-decoded image containing the first layer and a second layer higher than the first layer, and setting a second quad-tree to the second layer using the decoded quad-tree information.

According to an embodiment of the present disclosure, there is provided an image processing apparatus including an encoding section that encodes quad-tree information identifying a first quad-tree set to a first layer of a scalable-video-encoded image containing the first layer and a second layer higher than the first layer, the quad-tree information being used to set a second quad-tree to the second layer.

The image processing device mentioned above may be typically realized as an image encoding device that encodes an image.

According to an embodiment of the present disclosure, there is provided an image processing method including encoding quad-tree information identifying a first quad-tree set to a first layer of a scalable-video-encoded image containing the first layer and a second layer higher than the first layer, the quad-tree information being used to set a second quad-tree to the second layer.

### Advantageous Effects of Invention

According to the present disclosure, a mechanism capable of efficiently encoding and decoding quad-tree information for scalable video coding can be provided.

### BRIEF DESCRIPTION OF DRAWINGS

FIG. 1 is a block diagram showing a configuration of an image coding device according to an embodiment.

FIG. 2 is an explanatory view illustrating space scalability

FIG. 3 is an explanatory view illustrating SNR scalability.

FIG. 4 is a block diagram showing an example of a detailed configuration of an adaptive offset section shown in FIG. 1.

FIG. 5 is an explanatory view illustrating a band offset (BO).

FIG. 6 is an explanatory view illustrating an edge offset (EO).

FIG. 7 is an explanatory view showing an example of settings of an offset pattern to each partition of a quad-tree structure.

FIG. 8 is a block diagram showing an example of a detailed configuration of an adaptive loop filter shown in FIG. 1.

FIG. 9 is an explanatory view showing an example of settings of a filter coefficient to each partition of the quad-tree structure.

FIG. 10 is a block diagram showing an example of a detailed configuration of a lossless encoding section shown in FIG. 1.

FIG. 11 is an explanatory view illustrating quad-tree information to set a coding unit (CU).

FIG. 12 is an explanatory view illustrating split information that can additionally be encoded in an enhancement layer.

FIG. 13 is a flow chart showing an example of a flow of an adaptive offset process by the adaptive offset section shown in FIG 1.

FIG. 14 is a flow chart showing an example of the flow of an adaptive loop filter process by the adaptive loop filter shown in FIG 1.

FIG. 15 is a flow chart showing an example of the flow of an encoding process by the lossless encoding section shown in FIG. 1.

FIG. 16 is a block diagram showing an example of a configuration of an image decoding device according to an embodiment.

FIG. 17 is a block diagram showing an example of a detailed configuration of a lossless decoding section shown in FIG. 16.

FIG. 18 is a block diagram showing an example of a detailed configuration of an adaptive offset section shown in FIG. 16.

FIG. 19 is a block diagram showing an example of a detailed configuration of an adaptive loop filter shown in FIG. 16.

FIG. 20 is a flow chart showing an example of the flow of a decoding process by the lossless decoding section shown in FIG. 16.

FIG. 21 is a flow chart showing an example of the flow of the adaptive offset process by the adaptive offset section shown in FIG. 16.

FIG. 22 is a flow chart showing an example of the flow of the adaptive loop filter process by the adaptive loop filter shown in FIG. 16.

FIG. 23 is a block diagram showing an example of a schematic configuration of a television.

FIG. 24 is a block diagram showing an example of a schematic configuration of a mobile phone.

FIG. 25 is a block diagram showing an example of a schematic configuration of a recording/reproduction device.

FIG. 26 is a block diagram showing an example of a schematic configuration of an image capturing device.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

The description will be provided in the order shown below:

1. Configuration Example of Image Encoding Device

1-1. Overall Configuration

1-2. Detailed Configuration of Adaptive Offset Section

1-3. Detailed Configuration of Adaptive Loop Filter

1-4. Detailed Configuration of Lossless Encoding Section

2. Example of Process Flow During Encoding

2-1. Adaptive Offset Process

2-2. Adaptive Loop Filter Process

2-3. Encoding Process

3. Configuration Example of image Decoding Device

3-1. Overall Configuration

3-2. Detailed Configuration of Lossless Decoding Section

3-3. Detailed Configuration of Adaptive Offset Section

3-4. Detailed Configuration of Adaptive Loop Filter

4. Example of Process Flow During Decoding

4-1. Decoding Process

4-2. Adaptive Offset Process

4-3. Adaptive Loop Filter Process

5. Application Example

6. Summary

### 1. EXAMPLE CONFIGURATION OF IMAGE ENCODING DEVICE ACCORDING TO AN EMBODIMENT

### 1-1. Overall Configuration

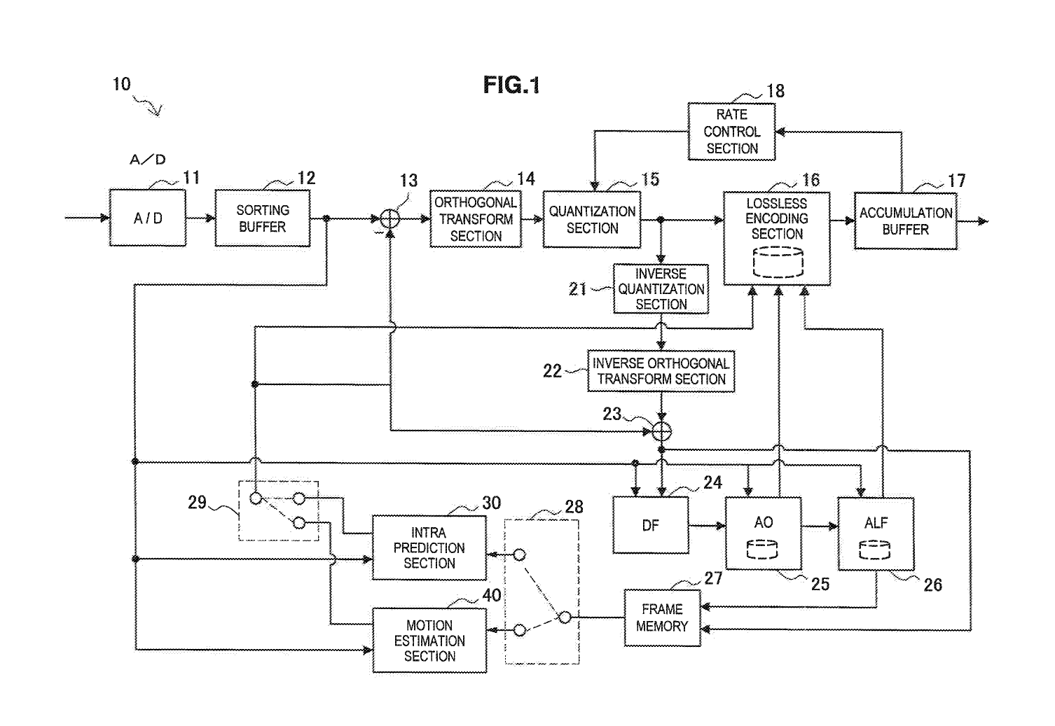

FIG. 1 is a block diagram showing an example of a configuration of an image encoding device 10 according to an embodiment. Referring to FIG. 1, the image encoding device 10 includes an A/D (Analogue to Digital) conversion section 11, a sorting buffer 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter (DF) 24, an adaptive offset section (AO) 25, an adaptive loop filter (ALF) 26, a frame memory 27, selectors 28 and 29, an intra prediction section 30 and a motion estimation section

The A/D conversion section 11 converts an image signal input in an analogue format into image data in a digital format, and outputs a series of digital image data to the sorting buffer 12.

The sorting buffer 12 sorts the images included in the series of image data input from the A/D conversion section 11. After sorting the images according to the a GOP (Group of Pictures) structure according to the encoding process, the sorting buffer 12 outputs the image data which has been sorted to the subtraction section 13, the intra prediction section 30 and the motion estimation section 40.

The image data input from the sorting buffer 12 and predicted image data input by the intra prediction section 30 or the motion estimation section 40 described later are supplied to the subtraction section 13. The subtraction section 13 calculates predicted error data which is a difference between the image data input from the sorting buffer 12 and the predicted image data and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16 and the inverse quantization section 21. Also, the quantization section 15 switches a quantization parameter (a quantization scale) based on the rate control signal from the rate control section 18 to thereby change the bit rate of the quantized data to be input to the lossless encoding section 16.

The lossless encoding section 16 generates an encoded stream by performing a lossless encoding process on quantized data input from the quantization section 15. The lossless encoding by the lossless encoding section 16 may be, for example, variable-length encoding or arithmetic encoding. In addition, the lossless encoding section 16 multiplexes header information into a sequence parameter set, a picture parameter set, or a header region such as a slice header. The header information encoded by the lossless encoding section 16 may contain quad-tree information, split information, offset information, filter coefficient information, PU setting information, and TU setting information described later. The header information encoded by the lossless encoding section 16 may also contain information about an intra prediction or an inter prediction input from the selector 29. Then, the lossless encoding section 16 outputs the generated encoded stream to the accumulation buffer 17.

The accumulation buffer 17 temporarily accumulates an encoded stream input from the lossless encoding section 16. Then, the accumulation buffer 17 outputs the accumulated encoded stream to a transmission section (not shown) (for example, a communication interface or an interface to peripheral devices) at a rate in accordance with the band of a transmission path.

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input front the quantization section 15. Then, the inverse quantization section 21 outputs transform coefficient data acquired by the inverse quantization process to the inverse orthogonal transform section 22.

The inverse orthogonal transform in section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the intra prediction section 30 or the motion estimation section 40 to thereby generate decoded image data. Then, the addition section 23 outputs the generated decoded image data to the deblocking filter 24 and the frame memory 27.

The deblocking filter (DF) 24 performs a filtering process for reducing block distortion occurring at the time of encoding of an image. The deblocking filter 24 filters the decoded image data input from the addition section 23 to remove the block distortion, and outputs the decoded image data after filtering to the adaptive offset section 25.

The adaptive offset section 25 improves image quality of a decoded image by adding an adaptively decided offset value to each pixel value of the decoded image after DF. In the present embodiment, the adaptive offset process by the adaptive offset section 25 may be performed by the technique proposed by Non-Patent Literature 3 based on a block using the blocks arranged in an image in a quad-tree shape as the processing units. In this specification, the block to become the processing unit of the adaptive offset process by the adaptive offset section 25 is called a partition. As a result of the adaptive offset process, the adaptive offset section 25 outputs decoded image data having an offset pixel value to the adaptive loop filter 26. In addition, the adaptive offset section 25 outputs offset information showing a set of offset values and an offset pattern for each partition to the lossless encoding section 16.

The adaptive loop filter 26 minimizes a difference between a decoded image and an original image by filtering the decoded image after AO. The adaptive loop filter 26 is typically realized by using a Wiener filter. In the present embodiment, the adaptive loop filter process by the adaptive loop filter 26 may be performed by the technique proposed by Non-Patent Literature 2 based on a block using the blocks arranged in an image in a quad-tree shape as the processing units. In this specification, the block to become the processing unit of the adaptive loop filter process by the adaptive loop filter 26 is also called a partition. However, the arrangement of partitions used by the adaptive offset section 25 and the arrangement (that is, the quad-tree structure) of partitions by the adaptive loop filter 26 may be common or may not be common. As a result of the adaptive loop filter process, the adaptive loop filter 26 outputs decoded image data whose difference from the original image is minimized to the frame memory 27. In addition, the adaptive loop filter 26 outputs filter coefficient information showing the filter coefficient for each partition to the lossless encoding section 16.

The frame memory 27 stores, using a storage medium, the decoded image data input from the addition section 23 and the decoded image data after filtering input from the deblocking filter 24.

The selector 28 reads the decoded image data after ALF which is to be used for inter prediction from the frame memory 27, and supplies the decoded image data which has been read to the motion estimation section 40 as reference image data. Also, the selector 28 reads the decoded image data before DF which is to be used for intra prediction from the frame memory 27, and supplies the decoded image data which has been read to the intra prediction section 30 as reference image data.

In the inter prediction mode, the selector 29 outputs predicted image data as a result of inter prediction output from the motion estimation section 40 to the subtraction section 13 and also outputs information about the inter prediction to the lossless encoding section 16. In the intra prediction mode, the selector 29 outputs predicted image data as a result of intra prediction output from the intra prediction section 30 to the subtraction section 13 and also outputs information about the intra prediction to the lossless encoding section 16. The selector 29 switches the inter prediction mode and the intra prediction mode in accordance with the magnitude of a cost function value output from the intra prediction section 30 or the motion estimation section 40.

The intra prediction section 30 performs an intra prediction process for each block set inside an image based on (an original image data) to be encoded input from the sorting buffer 12 and decoded image data as reference image data supplied from the frame memory 27. Then, the intra prediction section 30 outputs information about the intra prediction including prediction mode information indicating the optimum prediction mode, the cost function value, and predicted image data to the selector 29.

The motion estimation section 40 performs a motion estimation process for an inter prediction (inter-frame prediction) based on original image data input from the sorting buffer 12 and decoded image data supplied via the selector 28. Then, the motion estimation section 40 outputs information about the inter prediction including motion vector information and reference image information, the cost function value, and predicted image data to the selector 29.

The image encoding device 10 repeats a series of encoding processes described here for each of a plurality of layers of an image to be scalable-video-coded. The layer to be encoded first is a layer called a base layer representing the roughest image. An encoded stream of the base layer may be independently decoded without decoding encoded streams of other layers. Layers other than the base layer are layers called enhancement layer representing finer images. Information contained in an encoded stream of the base layer is used for an encoded stream of an enhancement layer to enhance the coding efficiency. Therefore, to reproduce an image of an enhancement layer, encoded streams of both of the base layer and the enhancement layer are decoded. The number of layers handled in scalable video coding may be three or more. In such a case, the lowest layer is the base layer and remaining layers are enhancement layers. For an encoded stream of a higher enhancement layer, information contained in encoded streams of a lower enhancement layer and the base layer may be used for encoding and decoding. In this specification, of at least two layers having dependence, the layer on the side depended on is called a lower layer and the layer on the depending side is called an upper layer.

In scalable video coding by the image encoding device 10, quad-tree information of the lower layer is reused in the upper layer to efficiently encode quad-tree information. More specifically, the lossless encoding section 16 shown in FIG. 1 includes a buffer that buffers quad-tree information of the lower layer to set the coding unit (CU) and can determine the CU structure of the upper layer using the quad-tree information. The adaptive offset section 25 includes a buffer that buffers quad-tree information of the lower layer to set a partition of the adaptive offset process and can arrange a partition in the upper layer using the quad-tree information. The adaptive loop filter 26 also includes a buffer that buffers quad-tree information of the lower layer to set a partition of the adaptive loop filter process and can arrange a partition in the upper layer using the quad-tree information. In this specification, examples in which the lossless encoding section 16, the adaptive offset section 25, and the adaptive loop filter 26 each reuse the quad-tree information will mainly be described. However, the present embodiment is not limited to such examples and any one or two of the lossless encoding section 16, the adaptive offset section 25, and the adaptive loop filter 26 may reuse the quad-tree information. In addition, the adaptive offset section 25 and the adaptive loop filter 26 may be omitted from the configuration of the image encoding device 10.

Typical attributes hierarchized in scalable video coding are mainly the following three types:
Space scalability: Spatial resolutions or image sizes are hierarchized.
Time scalability: Frame rates are hierarchized.
SNR (Signal to Noise Ratio) scalability: SN ratios are hierarchized.

Further, though not yet adopted in any standard, the bit depth scalability and chroma format scalability are also under discussion. The reuse of quad-tree information is normally effective when there is an image correlation between layers. An image correlation between layers can be present in types of scalability excluding the time scalability.

Thus, even if resolutions are different from each other, content of an image of the layer L1 is likely to be similar to content of an image of the layer L2. Similarly, content of an image of the layer L2 is likely to be similar to content of an image of the layer L3. This is an image correlation between layers in the space scalability.

Thus, even if bit rates are different from each other, content of an image of the layer L1 is likely to be similar to content of an image of the layer L2. Similarly, content of an image of the layer L2 is likely to be similar to content of an image of the layer L3. This is an image correlation between layers in the SNR scalability.

The image encoding device 10 according to the present embodiment focuses on such an image correlation between layers and reuses quad-tree information of the lower layer in the upper layer.

### 1-2. Detailed Configuration of Adaptive Offset Section

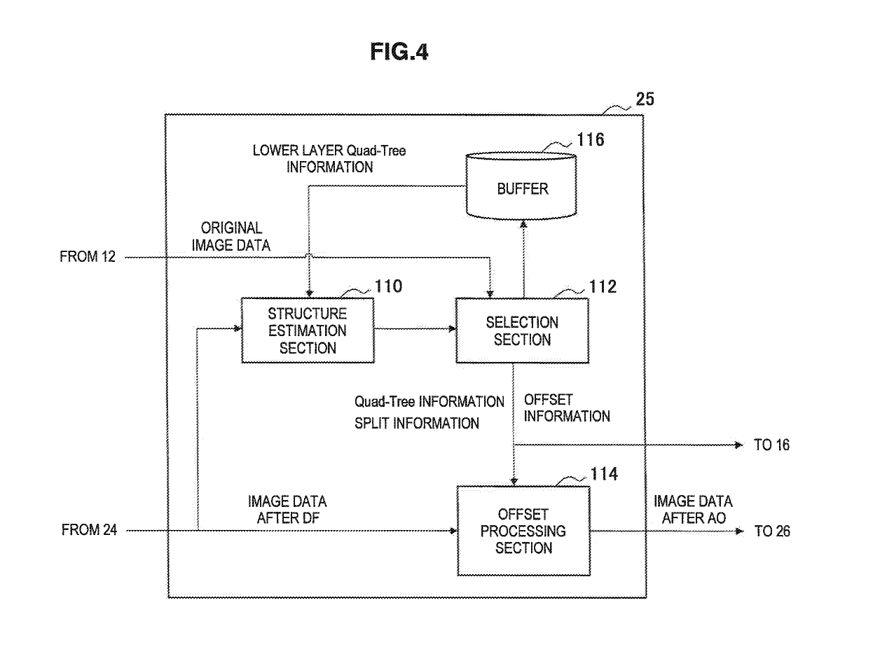

In this section, a detailed configuration of the adaptive offset section 25 shown in FIG. 1 will be described. FIG. 4 is a block diagram showing an example of a detailed configuration of the adaptive offset section 25. Referring to FIG. 4, the adaptive offset section 25 includes a structure estimation section 110, a selection section 112, an offset processing section 114, and a buffer 116.

(1) Base Layer

In an adaptive offset process of the base layer, the structure estimation section 110 estimates the optimum quad-tree structure to be set in an image. That is, the structure estimation section 110 first divides a decoded image after DF input from the deblocking filter 24 into one or more partitions. The division may recursively be carried out and one partition may further be divided into one or more partitions. The structure estimation section 110 calculates the optimum offset value among various offset patterns for each partition. In the technique proposed by Non-Patent Literature 3, nine candidates including two band offsets (BO), six edge offsets (EO), and no process (OFF) are present.

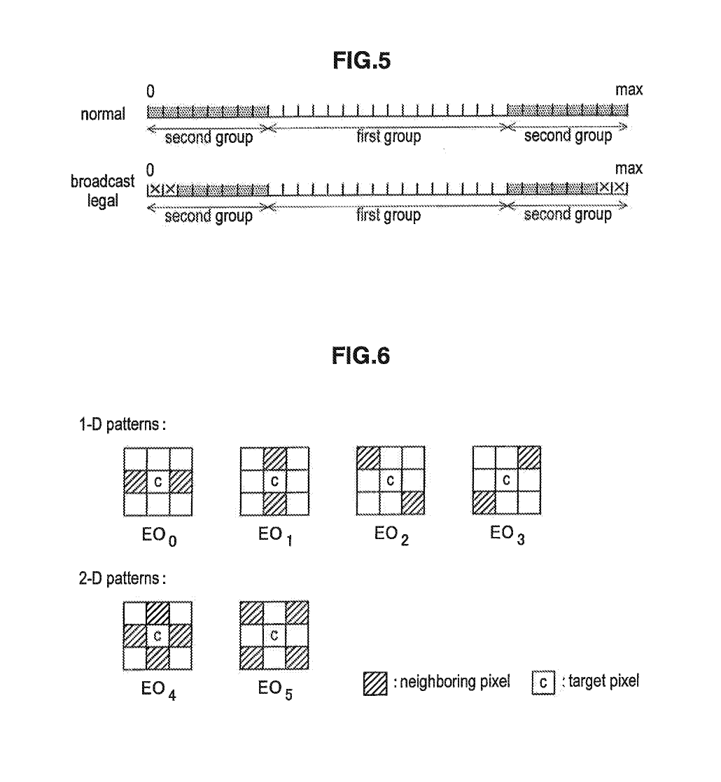

FIG. 5 is an explanatory view illustrating a band offset. In the band offset, as shown in FIG. 5, the range (for example, 0 to 255 for 8 bits) of the pixel value of luminance is classified into 32 bands. Then, an offset value is given to each band. The 32 bands are formed into a first group and a second group. The first group contains 16 bands positioned in the center of the range. The second group contains a total of 16 bands, eight of which are each positioned at both ends of the range. A first band offset (BO₁) as an offset pattern is a pattern to encode the offset value of a band of the first group of these two groups. A second band offset (BO₂) as an offset pattern is a pattern to encode the offset value of a band of the second group of these two groups. When the input image signal is a broadcast signal, the offset values of a total of four bands, two of which are each positioned at both ends, are not encoded like “broadcast legal” shown in FIG. 5, thereby reducing the amount of code for offset information.

FIG. 6 is an explanatory view illustrating an edge offset. As shown in FIG. 6, six offset patterns of the edge offset include four 1-D patterns and two 2-D patterns. These offset patterns each define a set of reference pixels referred to when each pixel is categorized. The number of reference pixels of each 1-D pattern is two. Reference pixels of a first edge offset (EO₀) are left and right neighboring pixels of the target pixel. Reference pixels of a second edge offset (EO₁) are upper and lower neighboring pixels of the target pixel. Reference pixels of a third edge offset (EO₂) are neighboring pixels at the upper left and lower right of the target pixel. Reference pixels of a fourth edge offset (EO₃) are neighboring pixels at the upper right and lower left of the target pixel. Using these reference pixels, each pixel in each partition is classified into one of five categories according to conditions shown in Table 1.

TABLE 1
Category classification conditions of the 1-D pattern

| Category | Conditions |
|---|---|
| 1 | c < 2 neighboring pixels |
| 2 | c < 1 neighbor && c == 1 neighbor |
| 3 | c > 1 neighbor && c == 1 neighbor |
| 4 | c > 2 neighbors |
| 0 | Nono of the above |

On the other hand, the number of reference pixels of each 2-D pattern is four. Reference pixels of a fifth edge offset (EO₄) are left and right, and upper and lower neighboring pixels of the target pixel. Reference pixels of a sixth edge offset (EO₅) are neighboring pixels at the upper left, upper right, lower right, and lower left of the target pixel. Using these reference pixels, each pixel in each partition is classified into one of seven categories according to conditions shown in Table 2.

TABLE 2
Category classification conditions of the 2-D pattern

| Category | Conditions |
|---|---|
| 1 | C < 4 neighbors |
| 2 | C < 3 neighbors && C = 4th neighbor |
| 3 | C < 3 neighbors && C > 4th neighbor |
| 4 | C > 3 neighbors && C < 4th neighbor |
| 5 | C > 3 neighbors && C = 4th neighbor |
| 6 | C > 4 neighbors |
| 0 | None of the above |

Then, an offset value is given to each category and encoded and an offset value corresponding to the category to which each pixel belongs is added to the pixel value of the pixel.

The structure estimation section 110 calculates the optimum offset value among these various offset patterns for each partition arranged in a quad-tree shape to generate an image after the offset process. The selection section 112 selects the optimum quad-tree structure, the offset pattern for each partition, and a set of offset values based on comparison of the image after the offset process and the original image. Then, the selection section 112 outputs quad-tree information representing a quad-tree structure and offset information representing offset patterns and offset values to the offset processing section 114 and the lossless encoding section 16. In addition, the quad-tree information is buffered by the buffer 116 for a process in the upper layer.

The offset processing section 114 recognizes the quad-tree structure of a decoded image of the base layer input from the deblocking filter 24 using quad-tree information input from the selection section 112 and adds an offset value to each pixel value according to the offset pattern selected for each partition. Then, the offset processing section 114 outputs decoded image data having an offset pixel value to the adaptive loop filter 26.

(2) Enhancement Layer

In the adaptive offset process of an enhancement layer, quad-tree information buffered by the buffer 116 is reused.

First, the structure estimation section 110 acquires quad-tree information set in an image in the lower layer and representing a quad-tree structure from the buffer 116. Then, the structure estimation section 110 arranges one or more partitions in the image of the enhancement layer according to the acquired quad-tree information. The arrangement of partitions as described above may simply be adopted as the quad-tree structure of the enhancement layer. Instead, the structure estimation section 110 may further divide (hereinafter, subdivide) an arranged partition into one or more partitions. The structure estimation section 110 calculates the optimum offset value among aforementioned various offset patterns for each partition arranged in a quad-tree shape to generate an image after the offset process. The selection section 112 selects the optimum quad-tree structure, the offset pattern for each partition, and a set of offset values based on comparison of the image after the offset process and the original image. When the quad-tree structure of the lower layer is subdivided, the selection section 112 generates split information to identify partitions to be subdivided. Then, the selection section 112 outputs the split information and offset information to the lossless encoding section 16. In addition, the selection section 112 outputs the quad-tree information of the lower layer, split information, and offset information to the offset processing section 114. The split information of an enhancement layer may be buffered by the buffer 116 for a process in the upper layer.

The offset processing section 114 recognizes the quad-tree structure of a decoded image of the enhancement layer input from the deblocking filter 24 using quad-tree information and split information input from the selection section 112 and adds an offset value to each pixel value according to the offset pattern selected for each partition. Then, the offset processing section 114 outputs decoded image data having an offset pixel value to the adaptive loop filter 26.

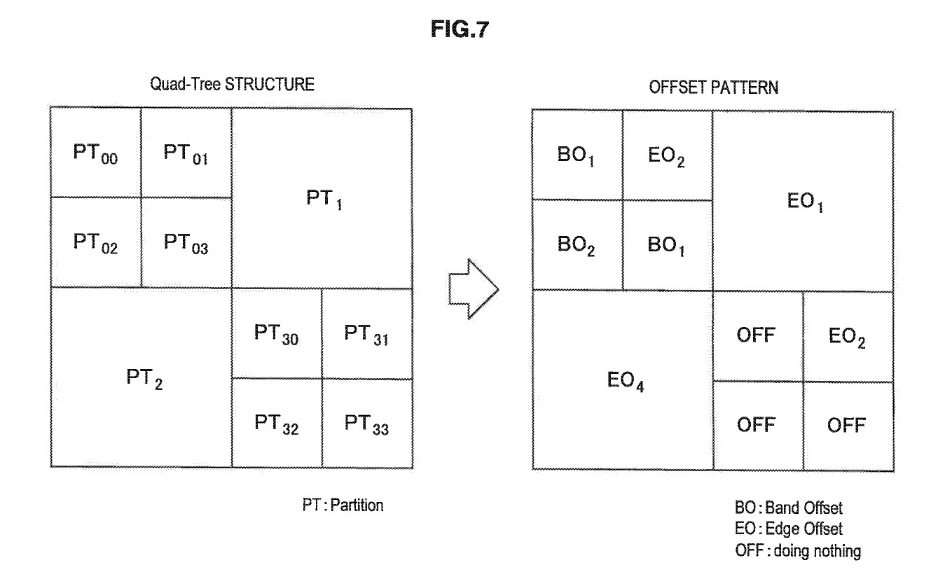

FIG. 7 is an explanatory view showing an example of settings of an offset pattern to each partition of a quad-tree structure. Referring to FIG. 7, 10 partitions PT₀₀ to PT₀₃, PT₁, PT₂ and PT₃₀ to PT₃₃ are arranged in a quad-tree shape in some LCU. Among these partitions, a band offset BO₁ is set to the partitions PT₀₀, PT₀₃, a band offset BO₂ is set to the partition PT₀₂, an edge offset EO₁ is set to the partition PT₁, an edge offset EO₂ is set to the partitions PT₀₁, PT₃₁, and an edge offset EO₄ is set to the partition PT₂. No process (OFF) is set to the remaining partitions PT₃₀, PT₃₂, and PT₃₃. In the present embodiment, offset information output from the selection section 112 to the lossless encoding section 16 represents an offset pattern for each partition and a set of offset values (an offset value by band and an offset value by category) for each offset pattern.

### 1-3. Detailed Configuration of Adaptive Loop Filter

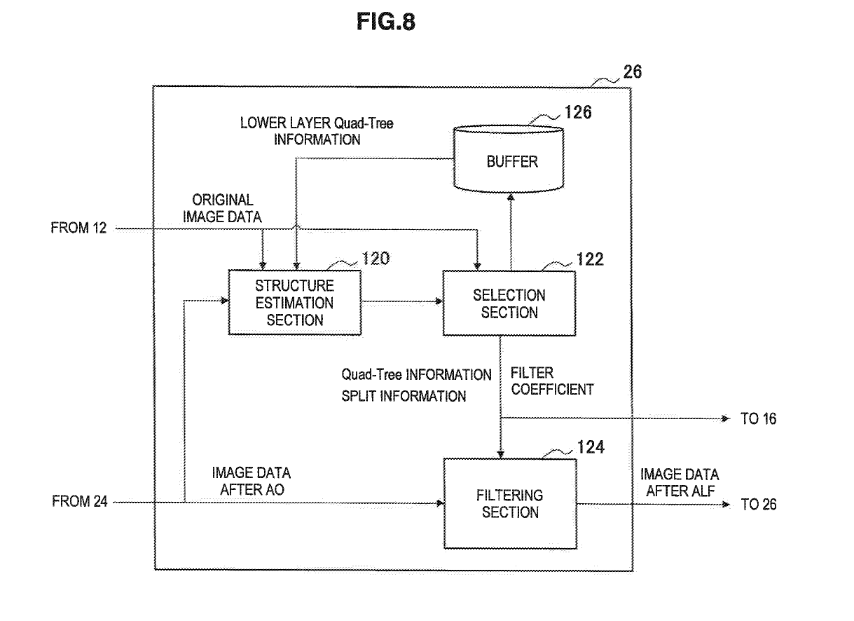

In this section, a detailed configuration of the adaptive loop filter 26 shown in FIG. 1 will be described. FIG. 8 is a block diagram showing an example of a detailed configuration of the adaptive loop filter 26. Referring to FIG. 8, the adaptive loop filter 26 includes a structure estimation section 120, a selection section 122, a filtering section 124, and a buffer 126.

(1) Base Layer

In an adaptive loop filter process of the base layer, the structure estimation section 120 estimates the optimum quad-tree structure to be set in an image. That is, the structure estimation section 120 first divides a decoded image after the adaptive offset process input from the adaptive offset section 25 into one or more partitions. The division may recursively be carried out and one partition may further be divided into one or more partitions. In addition, the structure estimation section 120 calculates a filter coefficient that minimizes a difference between an original image and a decoded image for each partition to generate an image after filtering. The selection section 122 selects the optimum quad-tree structure and a set of filter coefficients for each partition based on comparison between an image after filtering and the original image. Then, the selection section 122 outputs quad-tree information representing a quad-tree structure and filter coefficient information representing filter coefficients to the filtering section 124 and the lossless encoding section 16. In addition, the quad-tree information is buffered by the buffer 126 for a process in the upper layer.

The filtering section 124 recognizes the quad-tree structure of a decoded image of the base layer using quad-tree information input from the selection section 122. Next, the filtering section 124 filters a decoded image of each partition using a Wiener filter having the filter coefficient selected for each partition. Then, the filtering section 124 outputs the filtered decoded image data to the frame memory 27.

(2) Enhancement Layer

In the adaptive loop filter process of an enhancement layer, quad-tree information buffered by the buffer 126 is reused.

First, the structure estimation section 120 acquires quad-tree information set in an image in the lower layer and representing a quad-tree structure from the buffer 126. Then, the structure estimation section 120 arranges one or more partitions in the image of the enhancement layer according to the acquired quad-tree information. The arrangement of partitions as described above may simply be adopted as the quad-tree structure of the enhancement layer. Instead, the structure estimation section 120 may further subdivide an arranged partition into one or more partitions. The structure estimation section 120 calculates a filter coefficient for each partition arranged in a quad-tree shape to generate an image after filtering. The selection section 122 selects the optimum quad-tree structure and a filter coefficient for each partition based on comparison between an image after filtering and the original image. When the quad-tree structure of the lower layer is subdivided, the selection section 122 generates split information to identify partitions to be subdivided. Then, the selection section 122 outputs the split information and filter coefficient information to the lossless encoding section 16. In addition, the selection section 122 outputs the quad-tree information of the lower layer, split information, and filter coefficient information to the filtering section 124. The split information of an enhancement layer may be buffered by the buffer 126 for a process in the upper layer.

The filtering section 124 recognizes the quad-tree structure of the decoded image of the enhancement layer input from the adaptive offset section 25 using quad-tree information and split information input from the selection section 122. Next, the filtering section 124 filters a decoded image of each partition using a Wiener filter having the filter coefficient selected for each partition. Then, the filtering section 124 outputs the filtered decoded image data to the frame memory 27.

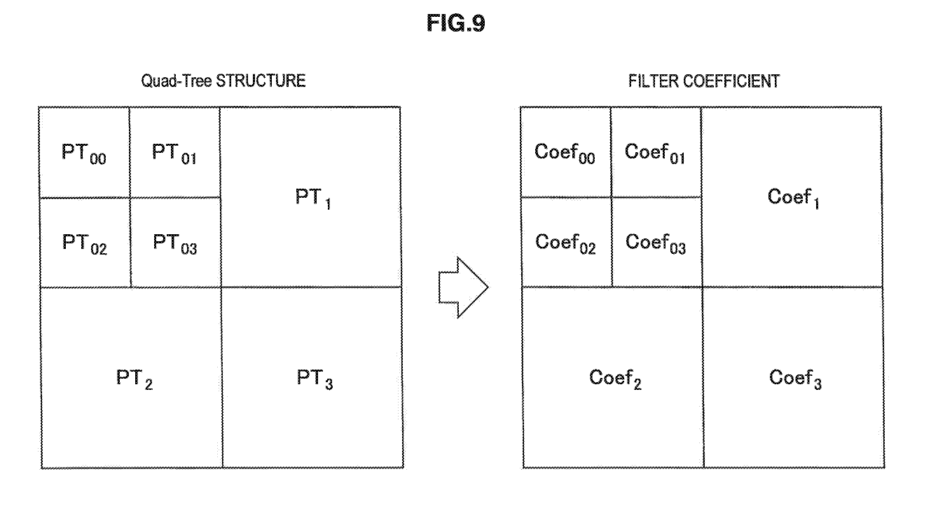

FIG. 9 is an explanatory view showing an example of settings of the filter coefficient to each partition of the quad-tree structure. Referring to FIG. 9, seven partitions PT₀₀ to PT₀₃, PT₁, PT₂, and PT₃ are arranged in a quad-tree shape in some LCU. The adaptive loop filter 26 calculates the filter coefficient for a Wiener filter for each of these partitions. As a result, for example, a set Coef₀₀ of filter coefficients is set to the partition PT₀₀. A set Coef₀₁ of filter coefficients is set to the partition PT₀₁. In the present embodiment, filter coefficient information output from the selection section 122 to the lossless encoding section 16 represents such a set of filter coefficients for each partition.

### [1-4. Detailed Configuration of Lossless Encoding Section]

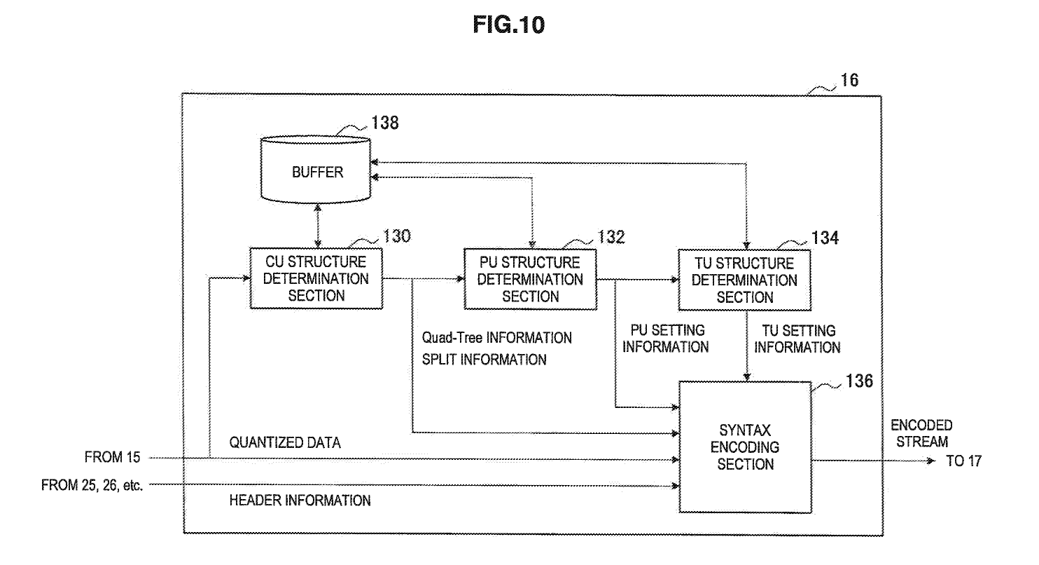

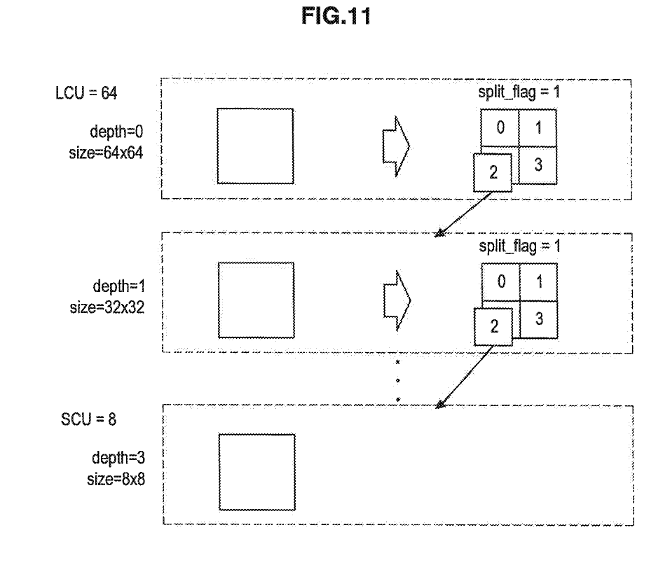

In this section, a detailed configuration of the lossless encoding section 16 shown in FIG. 1 will be described. FIG. 10 is a block diagram showing an example of a detailed configuration of the lossless encoding section 16. Referring to FIG. 10, the lossless encoding section 16 includes a CU structure determination section 130, a PU structure determination section 132, a TU structure determination section 134, a syntax encoding section 136, and a buffer 138.

In HEVC, as described above, coding units (CU) set in an image in a quad-tree shape become basic processing units of encoding and decoding of the image. The maximum settable coding unit is called LCU (Largest Coding Unit) and the minimum settable coding unit is called SCU (Smallest Coding Unit). The CU structure in LCU is identified by using a set of split_flag (split flags). In the example shown in FIG. 11, the LCU size is 64×64 pixels and the SCU size is 8×8 pixels. If split_flag=1 is specified when the depth is zero, the LCU of 64×64 pixels is divided into four CUs of 32×32 pixels. Further, if split_flag=1 is specified, the CU of 32×32 pixels is also divided into four CUs of 16×16 pixels. In this manner, the quad-tree structure of CU can be expressed by the sizes of LCU and SCU and a set of split_flag. Incidentally, the quad-tree structure of a partition used in the aforementioned adaptive offset process and adaptive loop filter may also be expressed similarly by the maximum partition size, the minimum partition size, and a set of split_flag.

If spatial resolutions are different between an enhancement layer and the lower layer when quad-tree information of the lower layer is reused in the enhancement layer, the LCU size or the maximum partition size enlarged in accordance with the ratio of the spatial resolutions is used as the LCU size or the maximum partition size for the enhancement layer. The SCU size or the minimum partition size may be enlarged in accordance with the ratio or may not be enlarged in consideration of the possibility of subdivision.

One coding unit can be divided into one or more prediction units (PU), which are processing units of an intra prediction and an inter prediction. Further, one prediction unit can be divided into one or more transform units (TU), which are processing units of an orthogonal transform. The quad-tree structures of these CU, PU, and TU can typically be decided in advance based on an offline image analysis.

(1) Base Layer

In an encoding process of e base layer, the CU structure determination section 130 determines the CU structure in a quad-tree shape set in an input image based on an offline image analysis result. Then, the CU structure determination section 130 generates quad-tree information representing the CU structure and outputs the generated quad-tree information to the PU structure determination section 132 and the syntax encoding section 136. The PU structure determination section 132 determines the PU structure set in each CU. Then, the PU structure determination section 132 outputs PU setting information representing the PU structure in each CU to the TU structure determination section 134 and the syntax encoding section 136. The TU structure determination section 134 determines the TU structure set in each PU. Then, the TU structure determination section 134 outputs TU setting information representing the TU structure in each PU to the syntax encoding section 136. The quad-tree information, PU setting information, and TU setting information are buffered by the buffer 138 for processes in the upper layer.

The syntax encoding section 136 generates an encoded stream of the base layer by performing a lossless encoding process on quantized data of the base layer input from the quantization section 15. In addition, the syntax encoding section 136 encodes header information input from each section of the image encoding device 10 and multiplexes the encoded header information into the header region of an encoded stream. The header information encoded here may contain quad-tree information and offset information input from the adaptive offset section 25 and quad-tree information and filter coefficient information input from the adaptive loop filter 26. In addition, the header information encoded by the syntax encoding section 136 may contain quad-tree information, PU setting information, and TU setting information input from the CU structure determination section 130, the PU structure determination section 132, and the TU structure determination section 134 respectively.

(2) Enhancement Layer

In the encoding process of an enhancement layer, information buffered by the buffer 138 is reused.

The CU structure determination section 30 acquires quad-tree information representing the quad-tree structure of CU set in each LCU in the lower layer from the buffer 138. The quad-tree information for CU acquired here typically contains the LCU size, SCU size, and a set of split_flag. If spatial resolutions are different between an enhancement layer and the lower layer, the LCU size may be enlarged in accordance with the ratio of the spatial resolutions. The CU structure determination section 130 determines the CU structure set in each LCU of the enhancement layer based on an offline image analysis result. Then, when the CU is subdivided in the enhancement layer, the CU structure determination section 130 generates split information and outputs the generated split information to the syntax encoding section 136.

The PU structure determination section 132 acquires PU setting information representing the structure of PU set in each CU in the lower layer from the buffer 138. The PU structure determination section 132 determines the PU structure set in each CU of the enhancement layer based on an offline image analysis result. When a PU structure that is different from the lower layer is used in the enhancement layer, the PU structure determination section 132 can additionally generate PU setting information and output the generated PU setting information to the syntax encoding section 136.

The TU structure determination section 134 acquires TU setting information representing the structure of TU set in each PU in the lower layer from the buffer 138. The TU structure determination section 134 determines the TU structure set in each PU of the enhancement layer based on an offline image analysis result. When a TU structure that is different from the lower layer is used in the enhancement layer, the TU structure determination section 134 can additionally generate TU setting information and output the generated TU setting information to the syntax encoding section 136.

The syntax encoding section 136 generates an encoded stream of an enhancement layer by performing a lossless encoding process on quantized data of the enhancement layer input from the quantization section 15. In addition, the syntax encoding section 136 encodes header information input from each section of the image encoding device 10 and multiplexes the encoded header information into the header region of an encoded stream. The header information encoded here may contain split information and offset information input from the adaptive offset section 25 and split information and filter coefficient information input from the adaptive loop filter 26. In addition, the header information encoded by the syntax encoding section 136 may contain split information, PU setting information, and TU setting information input from the CU structure determination section 130, the PU structure determination section 132, and the TU structure determination section 134 respectively.

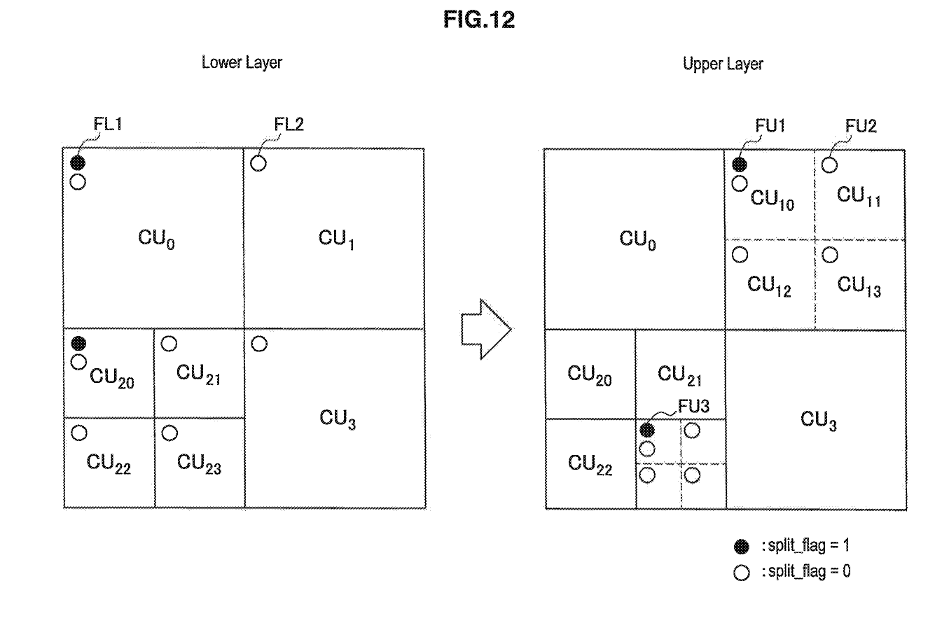

FIG. 12 is an explanatory view illustrating split information that can additionally be encoded in an enhancement layer. The quad-tree structure of CU in the lower layer is shown on the left side of FIG. 12. The quad-tree structure includes seven coding units CU₀, CU₁, CU₂₀ to CU₂₃, and CU₃. Also, some split flag encoded in the lower layer are shown. For example, the value of split_flag FL1 is 1, which indicates that the whole illustrated LCU is divided into four CUs. The value of split_flag FL2 is 0, which indicates that the coding unit CU₁ is not divided anymore. Similarly, other split_flag indicate whether the corresponding CU is further divided into a plurality of CUs.

The quad-tree structure of CU in the upper layer is shown on the right side of FIG. 12. In the quad-tree structure of the upper layer, the coding unit CU₁ of the lower layer is subdivided into four coding units CU₁₀ to CU₁₃. Also, the coding unit CU₂₃ of the lower layer is subdivided into four coding units. Split information that can additionally be encoded in the upper layer contains some split_flag related to these subdivisions. For example, the value of split_flag FU1 is 1, which indicates that the coding unit CU₁ is subdivided into four CUs. The value of split_flag FU2 is 0, which indicates that the coding unit CU₁₁ is not divided anymore. The value of split_flag FU3 is 1, which indicates that the coding unit CU₂₃ is subdivided into four CUs. Because such split information is encoded only for CU to be subdivided, the increased amount of code due to encoding of split information is small.

In FIG. 12, the quad-tree structure of CU is taken as an example to describe split information that can additionally be encoded in the enhancement layer. However, split information for the quad-tree structure of the enhancement layer set in the aforementioned adaptive offset process and adaptive loop filter process may also be expressed by a similar set of split flag representing the subdivision of each partition.

### 2. EXAMPLE OF PROCESS FLOW DURING ENCODING

### 2-1. Adaptive Offset Process

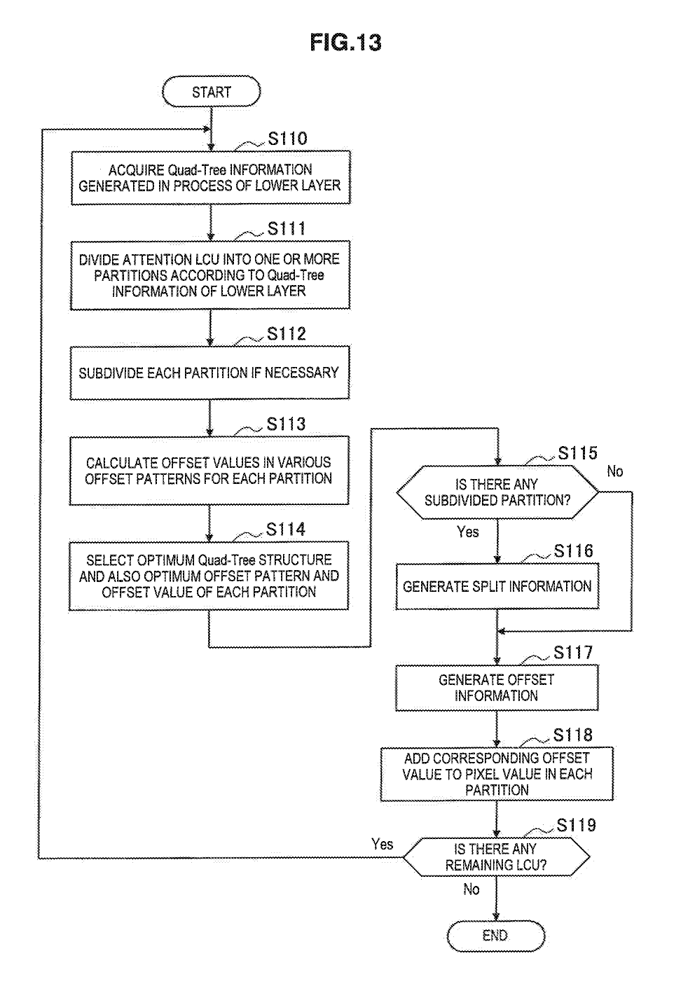

FIG. 13 is a flow chart showing an example of the flow of an adaptive offset process by the adaptive offset section 25 shown in FIG. 1. The flow chart in FIG. 13 shows the flow of a process intended for one enhancement layer of a plurality of layers of an image to be scalable-video-encoded. It is assumed that before the process described here, an adaptive offset process intended for the lower layer is performed and quad-tree information for the lower layer is buffered by the buffer 116. It is also assumed that a repetitive process is performed based on LCU.

Referring to FIG. 13, first the structure estimation section 110 of the adaptive offset section 25 acquires quad-tree information generated in a process of the lower layer from the buffer 116 (step S110). Next, the structure estimation section 110 divides the LCU to be processed (hereinafter, called an attention LCU) into one or more partitions according to the acquired quad-tree information of the lower layer (step S111). The structure estimation section 110 also subdivides each partition into one or more smaller partitions when necessary (step S112). Next, the structure estimation section 110 calculates the optimum offset value among aforementioned various offset patterns for each partition to generate an image after the offset process (step S113). Next, the selection section 112 selects the optimum quad-tree structure, the optimum offset pattern for each partition, and a set of offset values based on comparison of the image after the offset process and the original image (step S114).

Next, the selection section 112 determines whether there is any subdivided partition by comparing the quad-tree structure represented by quad-tree information of the lower layer and the quad-tree structure selected in step S114 (step S115). If there is a subdivided partition, the selection section 112 generates split information indicating that the partition of the quad-tree structure set to the lower layer is further subdivided (step S116). Next, the selection section 112 generates offset information representing the optimum offset pattern for each partition selected in step S114 and a set of offset values (step S117). The split information and offset information generated here can be encoded by the lossless encoding section 16 and multiplexed into the header region of an encoded stream of the enhancement layer. In addition, the split information can be buffered by the buffer 116 for a process of a higher layer.

Next, the offset processing section 114 adds the corresponding offset value to the pixel value in each partition inside the attention LCU according to the offset pattern selected for the partition (step S118). Decoded image data having a pixel value offset as described above is output to the adaptive loop filter 26.

Then, if there is any LCU not yet processed remaining in the layer to be processed, the process returns to step S110 to repeat the aforementioned process (step S119). On the other hand, if there is no remaining LCU not yet processed, the adaptive offset process shown in FIG. 13 ends. If any higher layer is present, the adaptive offset process shown in FIG. 13 may be repeated for the higher layer to be processed.

### 2-2. Adaptive Loop Filter Process

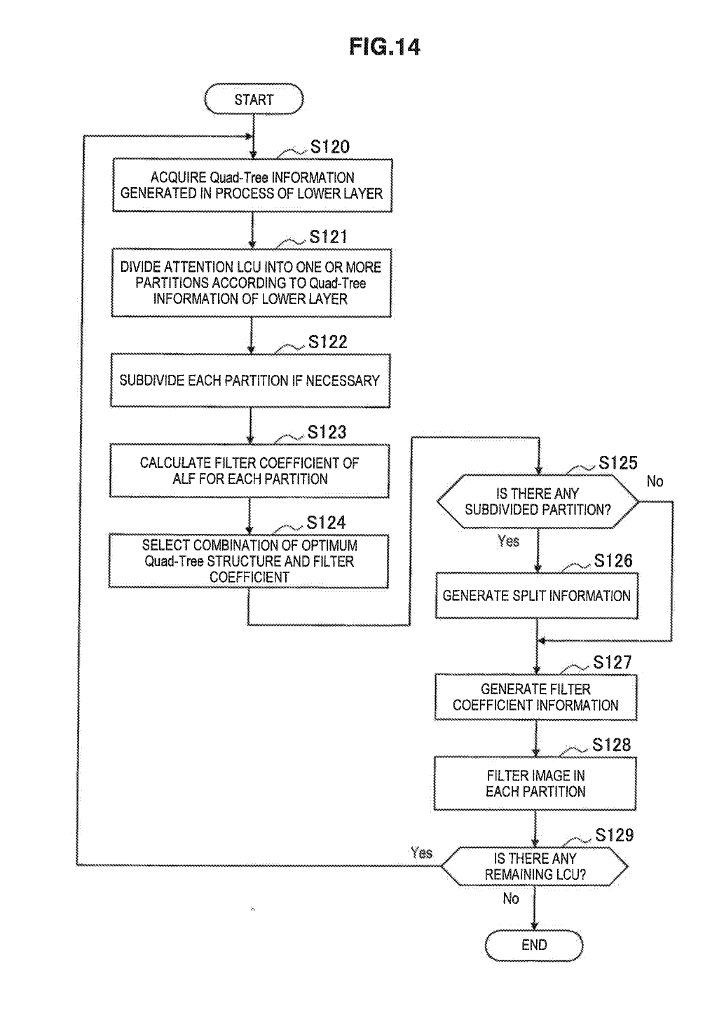

FIG. 14 is a flow chart showing an example of the flow of an adaptive loop filter process by the adaptive loop filter 26 shown in FIG. 1. The flow chart in FIG. 14 shows the flow of a process intended for one enhancement layer of a plurality of layers of an image to be scalable-video-encoded. It is assumed that before the process described here, an adaptive loop filter process intended for the lower layer is performed and quad-tree information for the lower layer is buffered by the buffer 126. It is also assumed that a repetitive process is performed based on LCU.

Referring to FIG. 14, first the structure estimation section 120 of the adaptive loop filter 26 acquires quad-tree information generated in a process of the lower layer from the buffer 126 (step S120). Next, the structure estimation section 120 divides the attention LCU into one or more partitions according to the acquired quad-tree information of the lower layer (step S121). The structure estimation section 120 also subdivides each partition into one or more smaller partitions when necessary (step S122). Next, the structure estimation section 120 calculates a filter coefficient that minimizes a difference between a decoded image and an original image for each partition to generate an image after filtering (step S123). Next, the selection section 122 selects a combination of the optimum quad-tree structure and a filter coefficient based on comparison between an image after filtering and the original image (step S124).

Next, the selection section 122 determines whether there is any subdivided partition by comparing the quad-tree structure represented by quad-tree information of the lower layer and the quad-tree structure selected in step S124 (step S125). If there is a subdivided partition, the selection section 122 generates split information indicating that the partition of the quad-tree structure set to the lower layer is further subdivided (step S126). Next, the selection section 122 generates filter coefficient information representing the filter coefficient of each partition selected in step S124 (step S127). The split information and filter coefficient information generated here can be encoded by the lossless encoding section 16 and multiplexed into the header region of an encoded stream of the enhancement layer. In addition, the split information can be buffered by the buffer 126 for a process of a higher layer.

Next, the filtering section 124 filters a decoded image in each partition inside the attention LCU using the corresponding filter coefficient (step S128). The decoded image data filtered here is output to the frame memory 27.

Then, if there is any LCU not yet processed remaining in the layer to be processed, the process returns to step S120 to repeat the aforementioned process (step S129). On the other hand, if there is no remaining LCU not yet processed, the adaptive loop filter process shown in FIG. 14 ends. If any higher layer is present, the adaptive loop filter process shown in FIG. 14 may be repeated for the higher layer to be processed.

### 2-3. Encoding Process

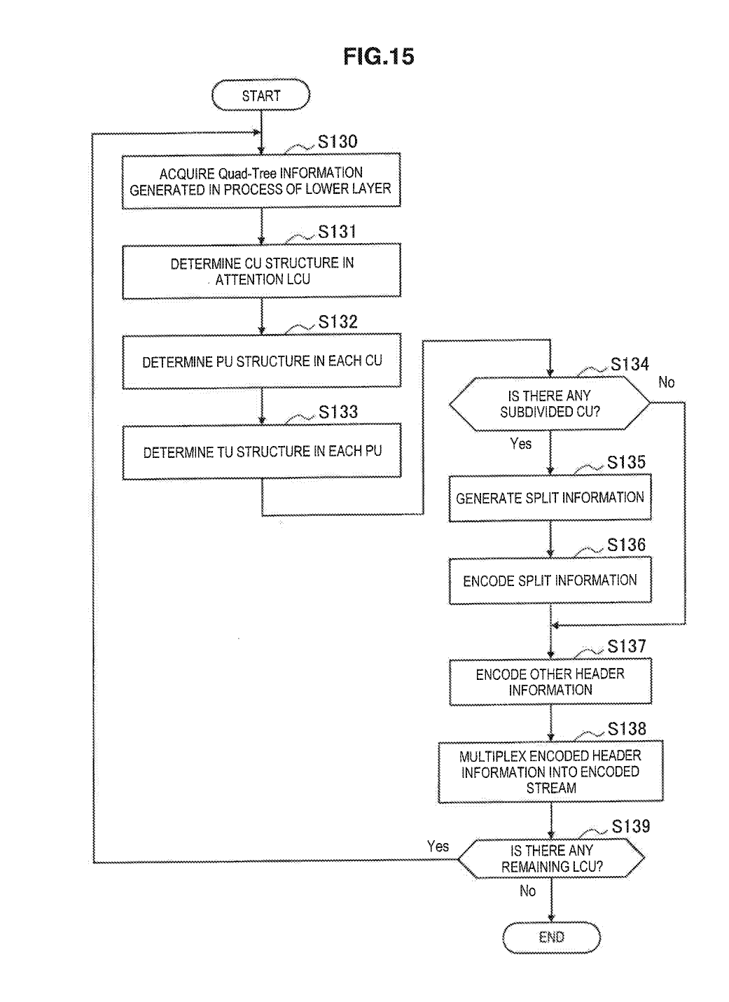

FIG. 15 is a flow chart showing an example of the flow of an encoding process by the lossless encoding section 16 shown in FIG. 1. The flow chart in FIG. 15 shows the flow of a process intended for one enhancement layer of a plurality of layers of an image to be sealable-video-encoded. It is assumed that before the process described here, an encoding process intended for the lower layer is performed and quad-tree information for the lower layer is buffered by the buffer 138. It is also assumed that a repetitive process is performed based on LCU.

Referring to FIG. 13, first the CU structure determination section 130 of the lossless encoding section 16 acquires quad-tree information generated in a process of the lower layer from the buffer 138 (step S130). Similarly, the PU structure determination section 132 acquires PU setting information generated in a process of the lower layer. Also, the TU structure determination section 134 acquires TU setting information generated in a process of the lower layer.

Next, the CU structure determination section 130 determines the CU structure set in the attention LCU (step S131). Similarly, the PU structure determination section 132 determines the PU structure set in each CU (step S132). The TU structure determination section 134 determines the TU structure set in each PU (step S133).

Next, the CU structure determination section 130 determines whether there is any subdivided CU by comparing the quad-tree structure represented by quad-tree information of the lower layer and the CU structure determined in step S131 (step S134). If there is a subdivided CU, the CU structure determination section 130 generates split information indicating that the CU set to the lower layer is further subdivided (step S135). Similarly, the PU structure determination section 132 and the TU structure determination section 134 can generate new PU setting information and TU setting information respectively.

Next, the syntax encoding section 136 encodes the split information generated by the CU structure determination section 130 (and PU setting information and TU setting information than can newly be generated) (step S136). Next, the syntax encoding section 136 encodes other header information (step S137). Then, the syntax encoding section 136 multiplexes encoded header information that can contain split information into the header region of an encoded stream containing encoded quantized data (step S138). The encoded stream of the enhancement layer generated as described above is output from the syntax encoding section 136 to the accumulation buffer 17.

Then, if there is any LCU not yet processed remaining in the layer to be processed, the process returns to step S130 to repeat the aforementioned process (step S139). On the other hand, if there is no remaining LCU not yet processed, the encoding process shown in FIG. 15 ends. If any higher layer is present, the encoding process shown in FIG. 15 may be repeated for the higher layer to be processed.

### 3. CONFIGURATION EXAMPLE OF IMAGE DECODING DEVICE

### 3-1. Overall Configuration

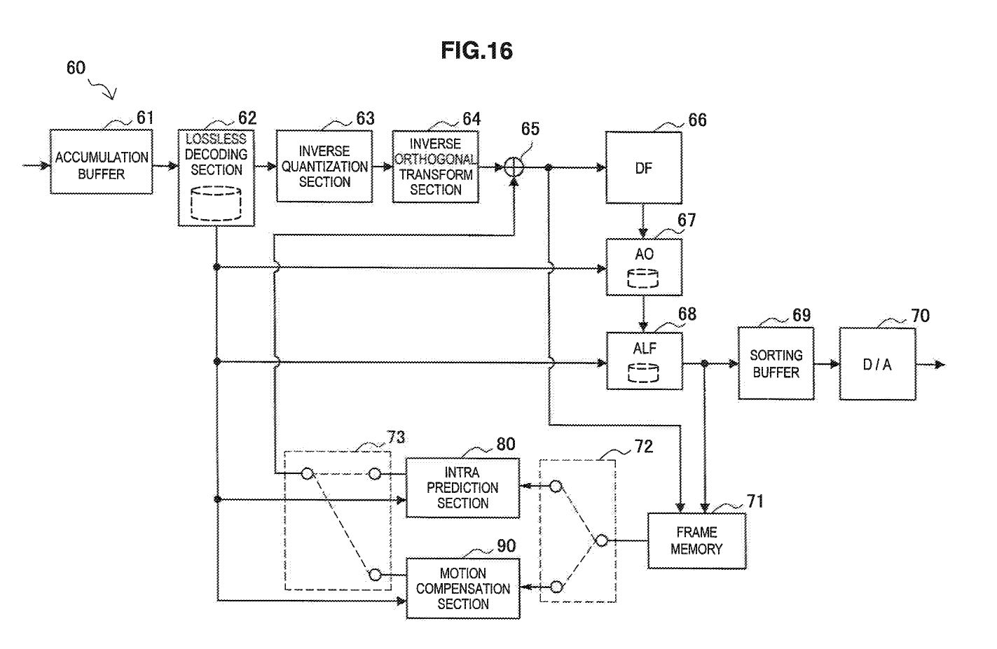

FIG. 16 is a block diagram showing an example of the configuration of an image decoding device 60 according to an embodiment. Referring to FIG. 16, the image decoding device 60 includes an accumulation buffer 61, a lossless decoding section 62, an inverse quantization section 63, an inverse orthogonal transform section 64, an addition section 65, a deblocking filter (DF) 66, an adaptive offset section (AO) 67, an adaptive loop filter (ALF) 68, a sorting buffer 69, a D/A (Digital to Analogue) conversion section 70, a frame memory 71, selectors 72, 73, an intra prediction section 80, and a motion compensation section 90.

The accumulation buffer 61 temporarily accumulates an encoded stream input via a transmission line.

The lossless decoding section 62 decodes an encoded stream input from the accumulation buffer 61 according to the encoding method used for encoding. Quantized data contained in the encoded stream is decoded by the lossless decoding section 62 and output to the inverse quantization section 63. The lossless decoding section 62 also decodes header information multiplexed into the header region of the encoded stream. The header information to be decoded here may contain, for example, the aforementioned quad-tree information, split information, offset information, filter coefficient information, PU setting information, and TU setting information. After decoding the quad-tree information, split information, PU setting information, and TU setting information about CU, the lossless decoding section 62 sets one or more CUs, PUs, and TUs in an image to be decoded. After decoding the quad-tree information, split information, and offset information about an adaptive offset process, the lossless decoding section 62 outputs decoded information to the adaptive offset section 67. After decoding the quad-tree information, split information, and filter coefficient information about an adaptive loop filter process, the lossless decoding section 62 outputs decoded information to the adaptive loop filter 68. Further, the header information to be decoded by the lossless decoding section 62 may include information about an inter prediction and information about an intra prediction. The lossless decoding section 62 outputs information about intra prediction to the intra prediction section 80. The lossless decoding section 62 also outputs information about inter prediction to the motion compensation section 90.

The inverse quantization section 63 inversely quantizes quantized data which has been decoded by the lossless decoding section 62. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 73 to thereby generate decoded image data Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the adaptive offset section 67.

The adaptive offset section 67 improves image quality of a decoded image by adding an adaptively decided offset value to each pixel value of the decoded image after DF. In the present embodiment, the adaptive offset process by the adaptive offset section 67 is performed in partitions arranged in a quad-tree shape in an image as the processing units using the quad-tree information, split information, and offset information to be decoded by the lossless decoding section 62. As a result of the adaptive offset process, the adaptive offset section 67 outputs decoded image data having an offset pixel value to the loop filter 68.

The adaptive loop filter 68 minimizes a difference between a decoded image and an original image by filtering the decoded image after AO. The adaptive loop filter 68 is typically realized by using a Wiener filter. In the present embodiment, the adaptive loop filter process by the adaptive loop filter 68 is performed in partitions arranged in a quad-tree shape in an image as the processing units using the quad-tree information, split information, and filter coefficient information to be decoded by the lossless decoding section 62. As a result of the adaptive loop filter process, the adaptive loop filter 68 outputs filtered decoded image data to the sorting buffer 69 and the frame memory 71.

The sorting buffer 69 generates a series of image data in a time sequence by sorting images input from the adaptive loop filter 68. Then, the sorting buffer 69 outputs the generated image data to the D/A conversion section 70.

The D/A conversion section 70 converts the image data in a digital format input from the sorting buffer 69 into an image signal in an analogue format. Then, the D/A conversion section 70 causes an image to be displayed by outputting the analogue image signal to a display (not shown) connected to the image decoding device 60, for example.

The frame memory 71 stores, using a storage medium, the decoded image data before DF input from the addition section 65, and the decoded image data after ALF input from the adaptive loop filter 68.

The selector 72 switches the output destination of image data from the frame memory 71 between the intra prediction section 80 and the motion compensation section 90 for each block in an image in accordance with mode information acquired by the lossless decoding section 62. When, for example, the intra prediction mode is specified, the selector 72 outputs decoded image data before DF supplied from the frame memory 71 to the intra prediction section 80 as reference image data. When the inter prediction mode is specified, the selector 72 outputs decoded image data after ALF supplied from the frame memory 71 to the motion compensation section 90 as reference image data.

The selector 73 switches the output source of predicted image data to be supplied to the addition section 65 between the intra prediction section 80 and the motion compensation section 90 in accordance with mode information acquired by the lossless decoding section 62. When, for example, the intra prediction mode is specified, the selector 73 supplies predicted image data output from the intra prediction section 80 to the addition section 65. When the inter prediction mode is specified, the selector 73 supplies predicted image data output from the motion compensation section 90 to the addition section 65.

The intra prediction section 80 performs an intra prediction process based on information about an intra prediction input from the lossless decoding section 62 and reference image data from the frame memory 71 to generate predicted image data. Then, the intra prediction section 80 outputs the generated predicted image data to the selector 73.

The motion compensation section 90 performs a motion compensation process based on information about an inter prediction input from the lossless decoding section 62 and reference image data from the frame memory 71 to generate predicted image data. Then, the motion compensation section 90 outputs predicted image data generated as a result of the motion compensation process to the selector 73.

The image decoding device 60 repeats a series of decoding processes described here for each of a plurality of layers of a scalable-video-coded image. The layer to be decoded first is the base layer. After the base layer is decoded, one or more enhancement layers are decoded. When an enhancement layer is decoded, information obtained by decoding the base layer or lower layers as other enhancement layers is used.

In scalable video coding by the image decoding device 60, quad-tree information of the lower layer is reused in the upper layer. More specifically, the lossless decoding section 62 shown in FIG. 16 includes a buffer that buffers quad-tree information of the lower layer to set the coding unit (CU) and sets the CU to the upper layer using the quad-tree information. The adaptive offset section 67 includes a buffer that buffers quad-tree information of the lower layer to set a partition of the adaptive offset process and sets a partition to the upper layer using the quad-tree information. The adaptive loop filter 26 also includes a buffer that buffers quad-tree information of the lower layer to set a partition of the adaptive loop filter process and sets a partition to the upper layer using the quad-tree information. In this specification, examples in which the lossless decoding section 62, the adaptive offset section 67, and the adaptive loop filter 68 each reuse the quad-tree information will mainly be described. However, the present embodiment is not limited to such examples and any one or two of the lossless decoding section 62, the adaptive offset section 67, and the adaptive loop filter 68 may reuse the quad-tree information. In addition, the adaptive offset section 67 and the adaptive loop filter 68 may be omitted from the configuration of the image decoding device 60.

### 3-2. Detailed Configuration of Lossless Decoding Section

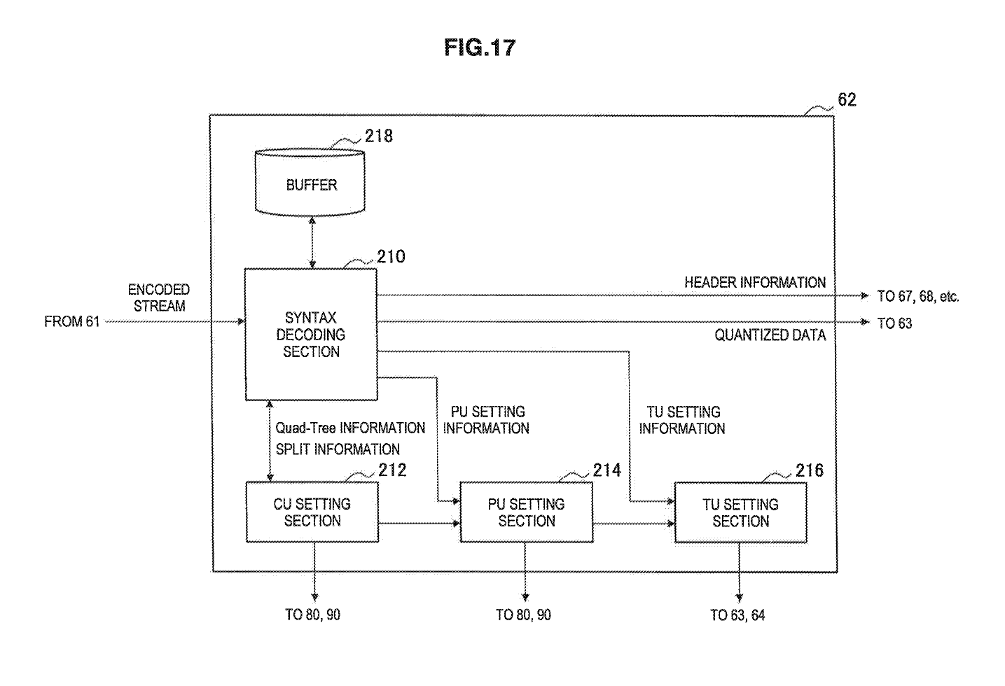

In this section, a detailed configuration of the lossless decoding section 62 shown in FIG. 16 will be described. FIG. 17 is a block diagram showing an example of a detailed configuration of the lossless decoding section 62. Referring to FIG. 17, the lossless decoding section 62 includes a syntax decoding section 210, a CU setting section 212, a PU setting section 214, a TU setting section 216, and a buffer 218.

(1) Base Layer

In an encoding process of the base layer, the syntax decoding section 210 decodes an encoded stream input from the accumulation buffer 61. After decoding quad-tree information for CU set to the base layer, the syntax decoding section 210 outputs the decoded quad-tree information to the CU setting section 212. The CU setting section 212 uses the quad-tree information decoded by the syntax decoding section 210 to set one or more CUs to the base layer in a quad-tree shape. Then, the syntax decoding section 210 decodes other header information and image data (quantized data) for each CU set by the CU setting section 212. Quantized data decoded by the syntax decoding section 210 is output to the inverse quantization section 63.

In addition, the syntax decoding section 210 outputs the decoded PU setting information and TU setting information to each of the PU setting section 214 and the TU setting section 216. The PU setting section 214 uses the PU setting information decoded by the syntax decoding section 210 to further set one or more PUs to each CU set by the CU setting section 212 in a quad-tree shape. Each PU set by the PU setting section 214 becomes the processing unit of an intra prediction process by the intra prediction section 80 or a motion compensation process by the motion compensation section 90. The TU setting section 216 uses the TU setting information decoded by the syntax decoding section 210 to further set one or more TUs to each PU set by the PU setting section 214. Each TU set by the TU setting section 216 becomes the processing unit of inverse quantization by the inverse quantization section 63 or an inverse orthogonal transform by the inverse orthogonal transform section 64.

The syntax decoding section 210 decodes quad-tree information and offset information for an adaptive offset process and outputs the decoded information to the adaptive offset section 67. The syntax decoding section 210 also decodes quad-tree information and filter coefficient information for an adaptive loop filter process and outputs the decoded information to the adaptive loop filter 68. Further, the syntax decoding section 210 decodes other header information and outputs the decoded information to the corresponding processing section (for example, the intra prediction section 80 for information about an intra prediction and the motion compensation section 90 for information about an inter prediction).

The buffer 218 buffers the quad-tree information for CU decoded by the syntax decoding section 210 for a process in the upper layer. PU setting information and TU setting information may be buffered like quad-tree information for CU or may be newly decoded in the upper layer.

(2) Enhancement Layer

In the encoding process of an enhancement layer, information buffered by the buffer 218 is reused.

The syntax decoding section 210 decodes an encoded stream of the enhancement layer input from the accumulation buffer 61. The syntax decoding section 210 first acquires the quad-tree information used for setting CU to the lower layer from the buffer 218 and outputs the acquired quad-tree information to the CU setting section 212. The CU setting section 212 uses the quad-tree information of the lower layer acquired by the syntax decoding section 210 to set one or more CUs having a quad-tree structure equivalent to that of the lower layer to an enhancement layer. The quad-tree information here typically contains the LCU size, SCU size, and a set of split_flag. If spatial resolutions are different between an enhancement layer and the lower layer, the LCU size may be enlarged in accordance with the ratio of the spatial resolutions. When header information of an encoded stream of the enhancement layer contains split information, the syntax decoding section 210 decodes the split information and outputs the decoded split information to the CU setting section 212. The CU setting section 212 can subdivide CU set by using the quad-tree information according to the split information decoded by the syntax decoding section 210. The syntax decoding section 210 decodes other header information and image data (quantized data) for each CU set by the CU setting section 212 as described above. Quantized data decoded by the syntax decoding section 210 is output to the inverse quantization section 63.

In addition, the syntax decoding section 210 outputs the decoded PU setting information and TU setting information acquired from the buffer 218 or newly decoded in the enhancement layer to each of the PU setting section 214 and the TU setting section 216. The PU setting section 214 uses the PU setting information input from the syntax decoding section 210 to further set one or more PUs to each CU set by the CU setting section 212 in a quad-tree shape. The TU setting section 216 uses the TU setting information input from the syntax decoding section 210 to further set one or more TUs to each PU set by the TU setting section 214.

The syntax decoding section 210 decodes an encoded stream of the enhancement layer into offset information for an adaptive offset process and outputs the decoded offset information to the adaptive offset section 67. If split information for the adaptive offset process is contained in the encoded stream, the syntax decoding section 210 decodes and outputs the split information to the adaptive offset section 67. In addition, the syntax decoding section 210 decodes an encoded stream of the enhancement layer into filter coefficient information for an adaptive loop filter process and outputs the decoded filter coefficient information to the adaptive loop filter 68. If split information for the adaptive loop filter process is contained in the encoded stream, the syntax decoding section 210 decodes and outputs the split information to the adaptive loop filter 68. Further, the syntax decoding section 210 decodes other header information and outputs the decoded information to the corresponding processing section.

When split information of an enhancement layer decoded by the syntax decoding section 210, PU setting information, or TU setting information is present, the buffer 218 may buffer the above information for a process in a still higher layer.

### 3-3. Detailed Configuration of Adaptive Offset Section

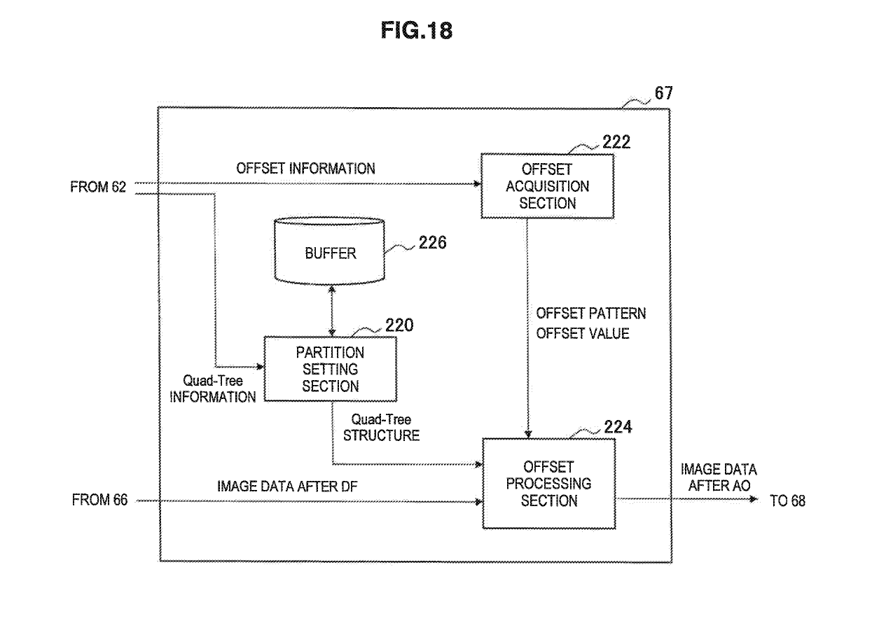

In this section, a detailed configuration of the adaptive offset section 67 shown in FIG. 16 will be described. FIG. 18 is a block diagram showing an example of a detailed configuration of the adaptive offset section 67. Referring to FIG. 18, the adaptive offset section 67 includes a partition setting section 220, an offset acquisition section 222, an offset processing section 224, and a buffer 226.

(1) Base Layer

In an adaptive offset process of the base layer, the partition setting section 220 acquires quad-tree information to be decoded by the lossless decoding section 62 from an encoded stream of the base layer. Then, the partition setting section 220 uses the acquired quad-tree information to set one or more partitions for an adaptive offset process to the base layer in a quad-tree shape. The offset acquisition section 222 acquires offset information for an adaptive offset process to be decoded by the lossless decoding section 62. The offset information acquired here represents, as described above, an offset pattern for each partition and a set of offset values for each offset pattern. Then, the offset processing section 224 uses the offset information acquired by the offset acquisition section 222 to perform an adaptive offset process for each partition set by the partition setting section 220. That is, the offset processing section 224 adds an offset value to each pixel value in each partition according to the offset pattern represented by the offset information. Then, the offset processing section 224 outputs decoded image data having an offset pixel value to the adaptive loop filter 68. The quad-tree information acquired by the partition setting section 220 is buffered by the buffer 226 for a process in the upper layer.

(2) Enhancement Layer

In the adaptive offset process of an enhancement layer, quad-tree information buffered by the buffer 226 is reused.

In the adaptive offset process of an enhancement layer, the partition setting section 220 acquires quad-tree information of the lower layer from the buffer 226. Then, the partition setting section 220 uses the acquired quad-tree information to set one or more partitions for an adaptive offset process to the enhancement layer. When split information is decoded by the lossless decoding section 62, the partition setting section 220 can acquire the decoded split information to subdivide a partition according to the acquired split information. The offset acquisition section 222 acquires offset information for an adaptive offset process to be decoded by the lossless decoding section 62. The offset processing section 224 uses the offset information acquired by the offset acquisition section 222 to perform an adaptive offset process for each partition set by the partition setting section 220. Then, the offset processing section 224 outputs decoded image data having an offset pixel value to the adaptive loop filter 68. The split information acquired by the partition setting section 220 may be buffered by the buffer 226 for a process in a still upper layer.

### 3-4. Detailed Configuration of Adaptive Loop Filter

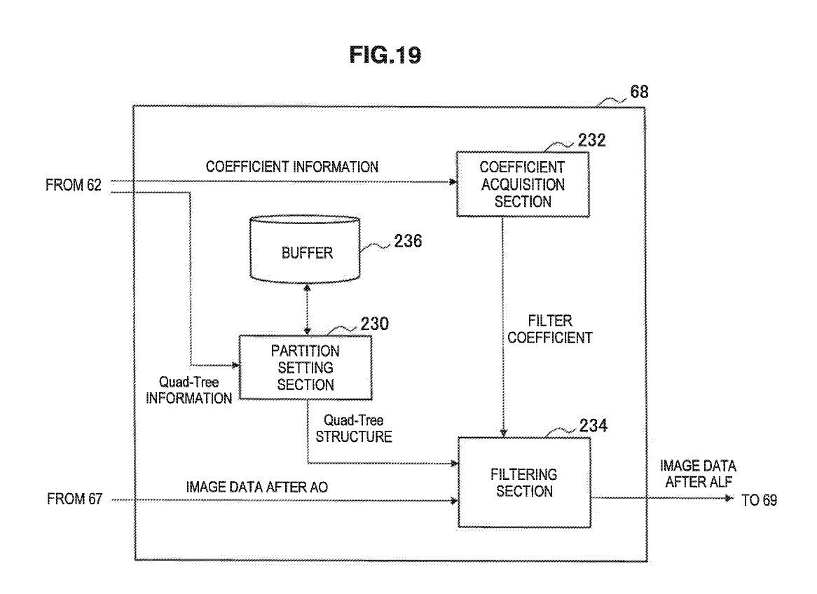

In this section, a detailed configuration of the adaptive loop filter 68 shown in FIG. 16 will be described. FIG. 19 is a block diagram showing an example of a detailed configuration of the adaptive loop filter 68. Referring to FIG. 19, the adaptive loop filter 68 includes a partition setting section 230, a coefficient acquisition section 232, a filtering section 234, and a buffer 236.

(1) Base Layer

In an adaptive loop filter process of the base layer, the partition setting section 230 acquires quad-tree information to be decoded by the lossless decoding section 62 from an encoded stream of the base layer. Then, the partition setting section 230 uses the acquired quad-tree information to set one or more partitions for an adaptive loop filter process to the base layer in a quad-tree shape. The coefficient acquisition section 232 acquires filter coefficient information for an adaptive loop filter process to be decoded by the lossless decoding section 62. The filter coefficient information acquired here represents, as described above, a set of filter coefficients for each partition. Then, the filtering section 234 filters decoded image data using a Wiener filter having a filter coefficient represented by the filter coefficient information for each partition set by the partition setting section 230. Then, the filtering section 234 outputs the filtered decoded image data to the sorting buffer 69 and the frame memory 71. The quad-tree information acquired by the partition setting section 230 is buffered by the buffer 236 for a process in the upper layer.

(2) Enhancement Layer

In the adaptive loop filter process of an enhancement layer, quad-tree information buffered by the buffer 236 is reused.

In the adaptive loop filter process of an enhancement layer, the partition setting section 230 acquires quad-tree information of the lower layer from the buffer 236. Then, the partition setting section 230 uses the acquired quad-tree information to set one or more partitions for an adaptive loop filter process to the enhancement layer. When split information is decoded by the lossless decoding section 62, the partition setting section 230 can acquire the decoded split information to subdivide a partition according to the acquired split information. The coefficient acquisition section 232 acquires filter coefficient information for an adaptive loop filter process to be decoded by the lossless decoding section 62. The filtering section 234 filters decoded image data using a Wiener filter having a filter coefficient represented by the filter coefficient information for each partition set by the partition setting section 230. Then, the filtering section 34 outputs the filtered decoded image data to the sorting buffer 69 and the frame memory 71. The split information acquired by the partition setting section 230 may be buffered by the buffer 236 for a process in a still upper layer.

### 4. EXAMPLE OF PROCESS FLOW DURING DECODING

### 4-1. Encoding Process

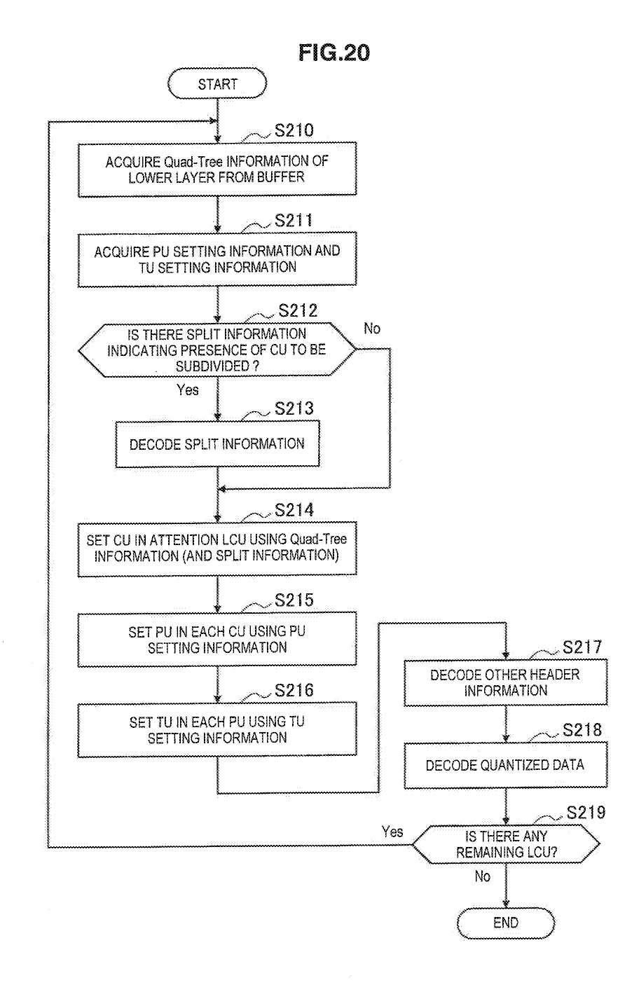

FIG. 20 is a flow chart showing an example of the flow of a decoding process by the lossless decoding section 62 shown in FIG. 16. The flow chart in FIG. 20 shows the flow of a process intended for one enhancement layer of a plurality of layers of an image to be scalable-video-decoded. It is assumed that before the process described here, a decoding process intended for the lower layer is performed and information about the lower layer is buffered by the buffer 218. It is also assumed that a repetitive process is performed based on LCU.

Referring to FIG. 20, the syntax decoding section 210 first acquires the quad-tree information used for setting CU to the lower layer from the buffer 218 (step S210). In addition, the syntax decoding section 210 newly decodes an encoded stream into PU setting information and TU setting information or acquires PU setting information and TU setting information from the buffer 218 (step S211).

Next, the syntax decoding section 210 determines whether split information indicating the presence of CU to be subdivided is present in the header region of an encoded stream (step S212). If the split information is present, the syntax decoding section 210 decodes the split information (step S213).

Next, the CU setting section 212 uses the quad-tree information used for setting CU in LCU of the lower layer corresponding to the attention LCU to set one or more CUs having a quad-tree structure equivalent to that of the lower layer in the attention LCU of the enhancement layer (step S214). If split information is present, the CU setting section 212 can subdivide CU according to the split information.

Next, the PU setting section 214 uses the PU setting information acquired by the syntax decoding section 210 to further set one or more PUs to each CU set by the CU setting section 212 (step S215).

Next, the TU setting section 216 uses the TU setting information acquired by the syntax decoding section 210 to further set one or more TUs to each PU set by the PU setting section 214 (step S216).

The syntax decoding section 210 also decodes other header information such as information about an intra prediction and information about an inter prediction (step S217). In addition, the syntax decoding section 210 decodes quantized data of the attention LCU contained in an encoded stream of the enhancement layer (step S218). Quantized data decoded by the syntax decoding section 210 is output to the inverse quantization section 63.

Then, if there is any LCU not yet processed remaining in the layer to be processed, the process returns to step S210 to repeat the aforementioned process (step S219). On the other hand, if there is no remaining LCU not yet processed, the decoding process shown in FIG. 20 ends. If any higher layer is present, the decoding process shown in FIG. 20 may be repeated for the higher layer to be processed.

### 4-2. Adaptive Offset Process

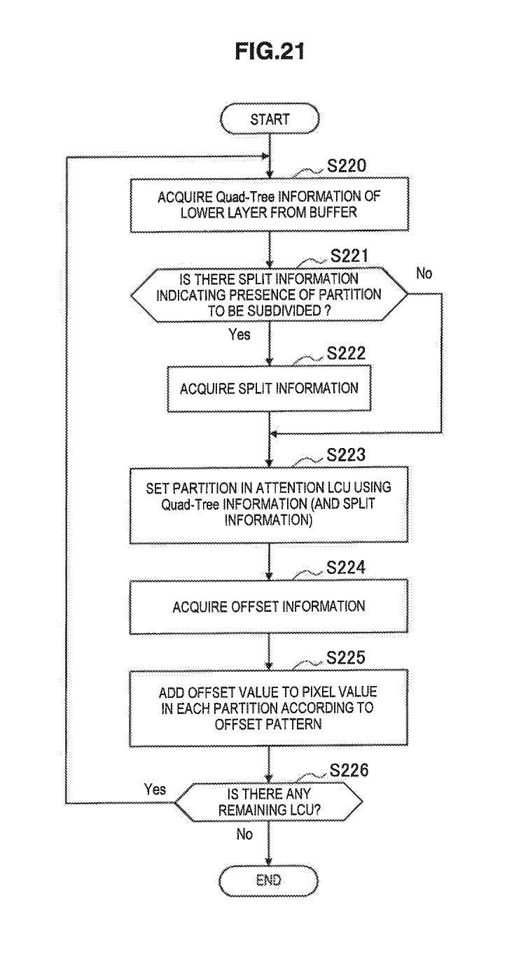

FIG. 21 is a flow chart showing an example of the flow of the adaptive offset process by the adaptive offset section 67 shown in FIG. 16. The flow chart in FIG. 21 shows the flow of a process intended for one enhancement layer of a plurality of layers of an image to be scalable-video-decoded. It is assumed that before the process described here, an adaptive offset process intended for the lower layer is performed and quad-tree information for the lower layer is buffered by the buffer 226. It is also assumed that a repetitive process is performed based on LCU.

Referring to FIG. 21, the partition setting section 220 first acquires the quad-tree information used for setting a partition to the lower layer from the buffer 226 (step S220).

Next, the partition setting section 220 determines whether split information indicating the presence of a partition to be subdivided is decoded by the lossless decoding section 62 (step S221). If split information has been decoded, the partition setting section 220 acquires the split information (step S222).

Next, the partition setting section 220 uses the quad-tree information used for setting a partition in LCU of the lower layer corresponding to the attention LCU to set one or more partitions having a quad-tree structure equivalent to that of the lower layer in the attention LCU of the enhancement layer (step S223). If split information is present, the partition setting section 220 can subdivide the partition according to the split information.

The offset acquisition section 222 acquires the offset information for an adaptive offset process decoded by the lossless decoding section 62 (step S224). The offset information acquired here represents an offset pattern for each partition in the attention LCU and a set of offset values for each offset pattern.

Next, the offset processing section 224 adds an offset value to the pixel value in each partition according to the offset pattern represented by the acquired offset information (step S225). Then, the offset processing section 224 outputs decoded image data having an offset pixel value to the adaptive loop filter 68.

Then, if there is any LCU not yet processed remaining in the layer to be processed, the process returns to step S220 to repeat the aforementioned process (step S226). On the other hand, if there is no remaining LCU not yet processed, the adaptive offset process shown in FIG. 21 ends. If any higher layer is present, the adaptive offset process shown in FIG. 21 may be repeated for the higher layer to be processed.

### 4-3. Adaptive Loop Filter Process

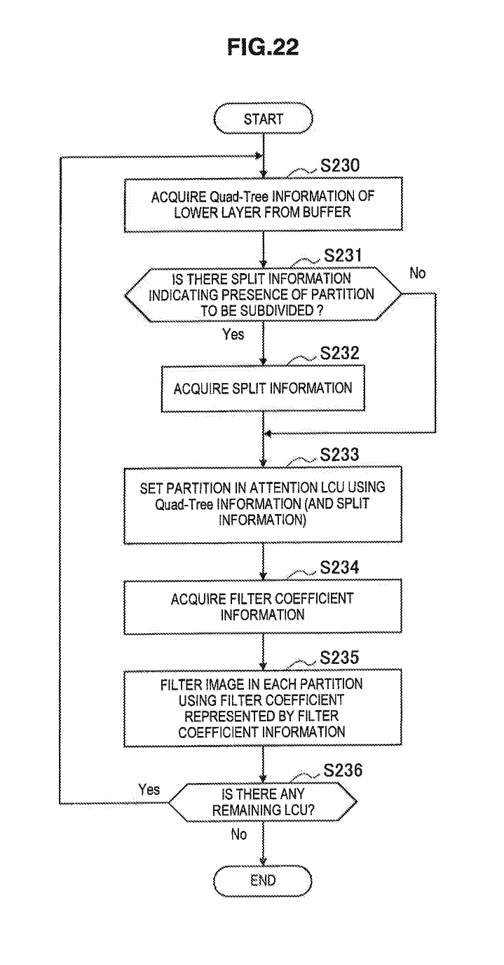

FIG. 22 is a flow chart showing an example of the flow of the adaptive loop filter process by the adaptive loop filter 68 shown in FIG. 16. The flow chart in FIG.

22 shows the flow of a process intended for one enhancement layer of a plurality of layers of an image to be scalable-video-decoded. It is assumed that before the process described here, an adaptive loop filter process intended for the lower layer is performed and quad-tree information for the lower layer is buffered by the buffer 236. It is also assumed that a repetitive process is performed based on LCU.

Referring to FIG. 22, the partition setting section 230 first acquires the quad-tree information used for setting a partition to the lower layer from the buffer 236 (step S230).

Next, the partition setting section 230 determines whether split information indicating the presence of a partition to be subdivided is decoded by the lossless decoding section 62 (step S231). If split information has been decoded, the partition setting section 230 acquires the split information (step S232).

Next, the partition setting section 230 uses the quad-tree information used for setting a partition in LCU of the lower layer corresponding to the attention LCU to set one or more partitions having a quad-tree structure equivalent to that of the lower layer in the attention LCU of the enhancement layer (step S233). If split information is present, the partition setting section 230 can subdivide the partition according to the split information.

The coefficient acquisition section 232 acquires filter coefficient information for an adaptive loop filter process decoded by the lossless decoding section 62 (step S234). The filter coefficient information acquired here represents a set of filter coefficients for each partition in the attention LCU.

Next, the filtering section 234 uses a set of filter coefficients represented by the acquired filter coefficient information to filter a decoded image in each partition (step S235). Then, the filtering section 234 outputs the filtered decoded image data to the sorting buffer 69 and the frame memory 71.

Then, if there is any LCU not yet processed remaining in the layer to be processed, the process returns to step S230 to repeat the aforementioned process (step S236). On the other hand, if there is no remaining LCU not yet processed, the adaptive loop filter process shown in FIG. 22 ends. If any higher layer is present, the adaptive loop filter process shown in FIG. 22 may be repeated for the higher layer to be processed.

### 5. EXAMPLE APPLICATION

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

### 5-1. First Application Example

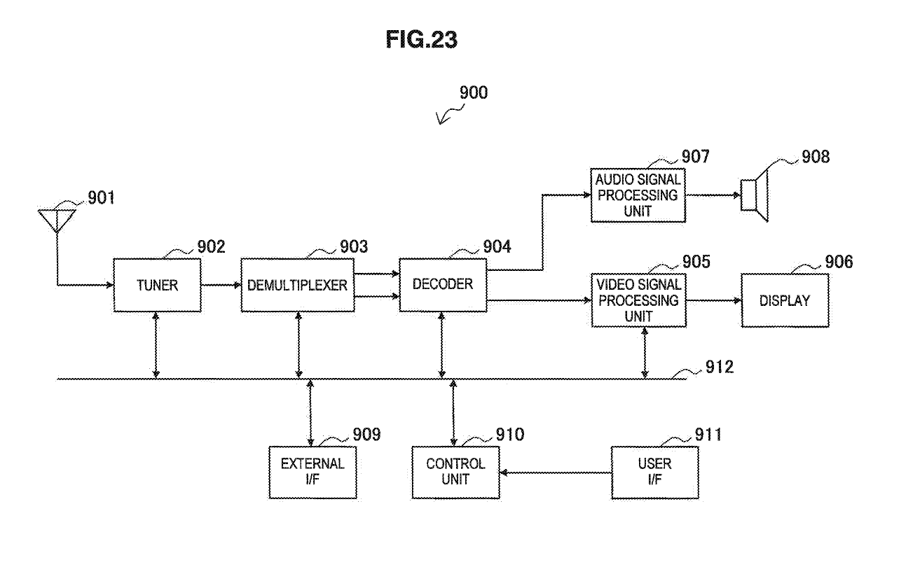

FIG. 23 is a diagram illustrating an example of a schematic configuration of a television device applying the aforementioned embodiment. A television device 900 includes an antenna 901, a tuner 902, a demultiplexer 903, a decoder 904, a video signal processing unit 905, a display 906, an audio signal processing unit 907, a speaker 908, an external interface 909, a control unit 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as transmission means receiving the encoded stream in which an image is encoded, in the television device 900.

The demultiplexer 903 isolates a video stream and an audio stream in a program to be viewed from the encoded bit stream and outputs each of the isolated streams to the decoder 904. The demultiplexer 903 also extracts auxiliary data such as an EPG (Electronic Program Guide) from the encoded bit stream and supplies the extracted data to the control unit 910. Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing unit 905. Furthermore, the decoder 904 outputs audio data generated by the decoding process to the audio signal processing unit 907.

The video signal processing unit 905 reproduces the video data input from the decoder 904 and displays the video on the display 906. The video signal processing unit 905 may also display an application screen supplied through the network on the display 906. The video signal processing unit 905 may further perform an additional process such as noise reduction on the video data according to the setting. Furthermore, the video signal processing unit 905 may generate an image of a GUI (Graphical User Interface) such as a menu, a button, or a cursor and superpose the generated image onto the output image.

The display 906 is driven by a drive signal supplied from the video signal processing unit 905 and displays video or an image on a video screen of a display device (such as a liquid crystal display, a plasma display, or an OELD (Organic ElectroLuminescence Display)).

The audio signal processing unit 907 performs a reproducing process such as D/A conversion and amplification on the audio data input from the decoder 904 and outputs the audio from the speaker 908. The audio signal processing unit 907 may also perform an additional process such as noise reduction on the audio data.

The external interface 909 is an interface that connects the television device 900 with an external device or a network. For example, the decoder 904 may decode a video stream or an audio stream received through the external interface 909. This means that the external interface 909 also has a role as the transmission means receiving the encoded stream in which an image is encoded, in the television device 900.

The control unit 910 includes a processor such as a CPU and a memory such as a RAM and a ROM. The memory stores a program executed by the CPU, program data, EPG data, and data acquired through the network. The program stored in the memory is read by the CPU at the start-up of the television device 900 and executed, for example. By executing the program, the CPU controls the operation of the television device 900 in accordance with an operation signal that is input from the user interface 911, for example.

The user interface 911 is connected to the control unit 910. The user interface 911 includes a button and a switch for a user to operate the television device 900 as well as a reception part which receives a remote control signal, for example. The user interface 911 detects a user operation through these components, generates the operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

The decoder 904 in the television device 900 configured in the aforementioned manner has a function of the image decoding device 60 according to the aforementioned embodiment. Accordingly, for scalable video encoding and decoding of images by the mobile telephone 920, the encoding efficiency can be further enhanced by reusing quad-tree information based on an image correlation between layers.

### 5-2. Second Application Example

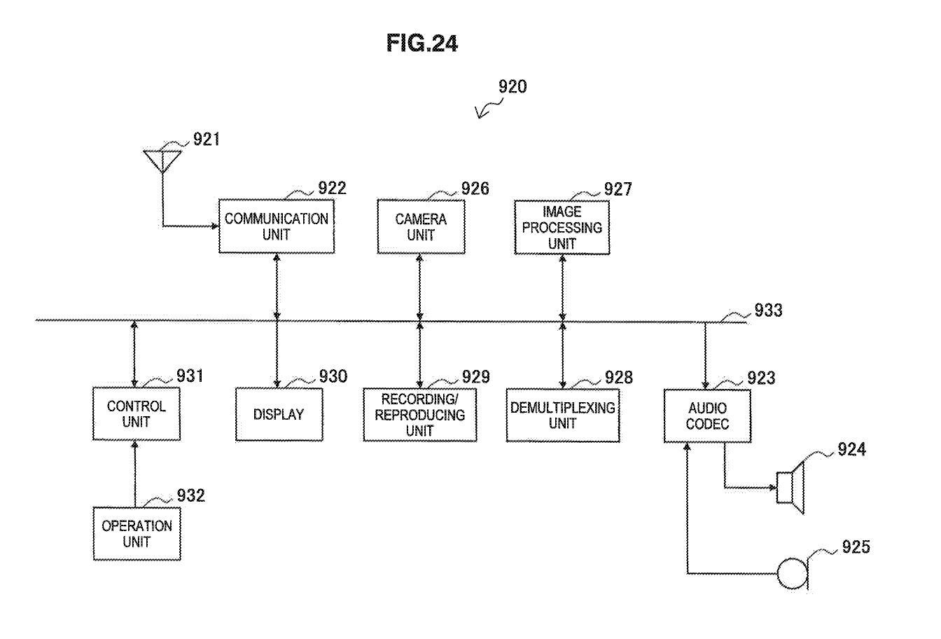

FIG. 24 is a diagram illustrating an example of a schematic configuration of a mobile telephone applying the aforementioned embodiment. A mobile telephone 920 includes an antenna 921, a communication unit 922, an audio codec 923, a speaker 924, a microphone 925, a camera unit 926, an image processing unit 927, a demultiplexing unit 928, a recording/reproducing unit 929, a display 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the demultiplexing unit 928, the recording/reproducing unit 929, the display 930, and the control unit 931.

The mobile telephone 920 performs an operation such as transmitting/receiving an audio signal, transmitting/receiving an electronic mail or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of the recording/reproducing unit 929.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the storing/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 subsequently transmits the generated transmission signal to the base station (not shown) through the antenna 921. Moreover, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then supplies the generated audio signal to the speaker 924 to output the audio.

The image processing unit 927 in the mobile telephone 920 configured in the aforementioned manner has a function of the image encoding device 10 and the image decoding device 60 according to the aforementioned embodiment. Accordingly, for scalable video coding and decoding of images by the mobile telephone 920, the encoding efficiency can be further enhanced by reusing quad-tree information based on an image correlation between layers.

### 5-3. Third Application Example

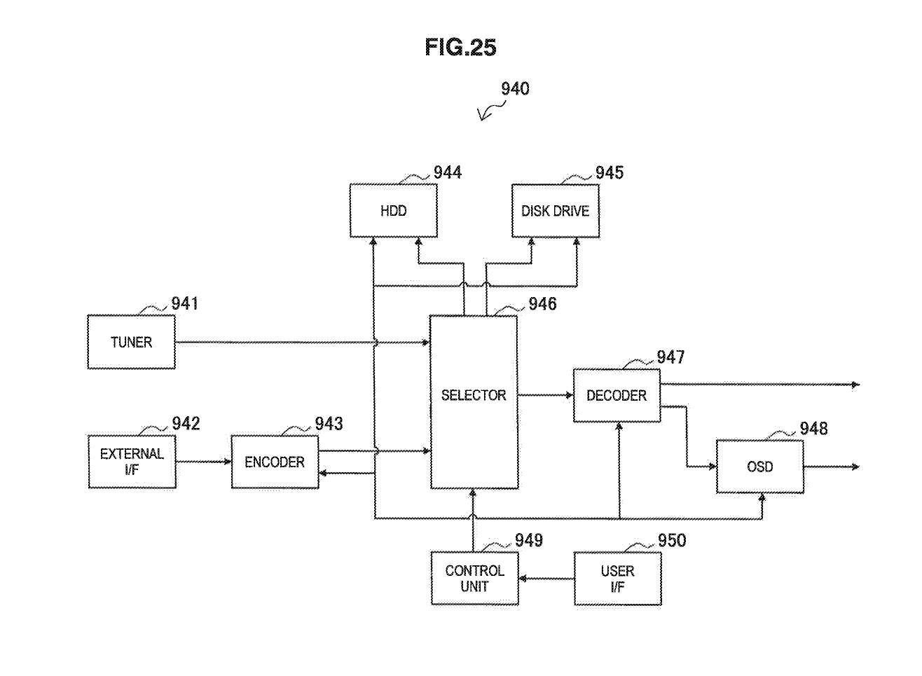

FIG. 25 is a diagram illustrating an example of a schematic configuration of a recording/reproducing device applying the aforementioned embodiment. A recording/reproducing device 940 encodes audio data and video data of a broadcast program received and records the data into a recording medium, for example. The recording/reproducing device 940 may also encode audio data and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording/reproducing device 940.

The encoder 943 encodes the video data and the audio data when the video data and the audio data input from the external interface 942 are not encoded. The encoder 943 thereafter outputs an encoded bit stream to the selector 946.

The HDD 944 records, into an internal hard disk, the encoded hit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded bit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a CPU and a memory such as a RAM and a ROM. The memory stores a program executed by the CPU as well as program data. The program stored in the memory is read by the CPU at the start-up of the recording/reproducing device 940 and executed, for example. By executing the program, the CPU controls the operation of the recording/reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

The encoder 943 in the recording/reproducing device 940 configured in the aforementioned manner has a function of the image encoding device 10 according to the aforementioned embodiment. On the other hand, the decoder 947 has a function of the image decoding device 60 according to the aforementioned embodiment. Accordingly, for scalable video encoding and decoding of images by the recording/reproducing device 940, the encoding efficiency can be further enhanced by reusing quad-tree information based on an image correlation between layers.

### 5-4. Fourth Application Example

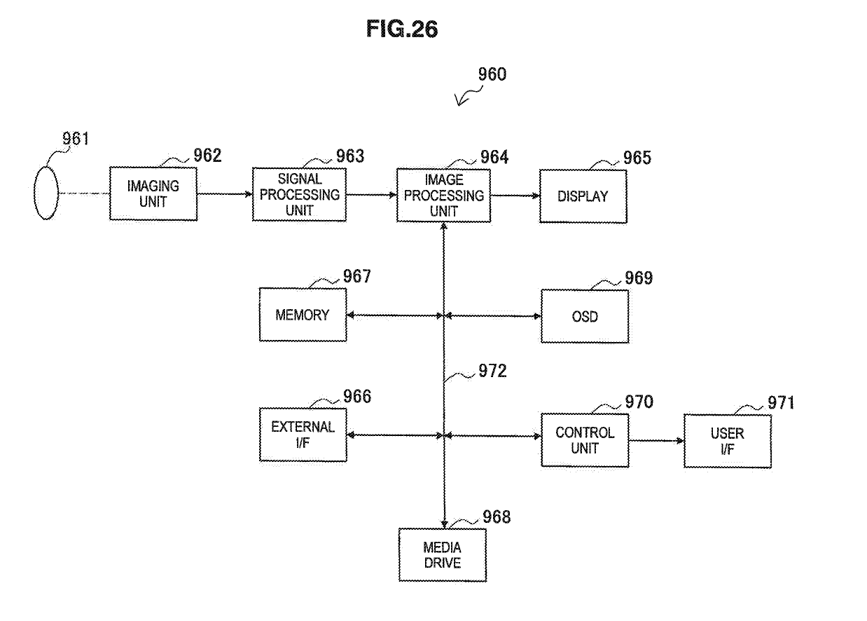

FIG. 26 is a diagram illustrating an example of a schematic configuration of an imaging device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of the object on an imaging surface of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging surface into an image signal as an electric signal. Subsequently, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964.

The external interface 966 is configured as a USB input/output terminal, for example. The external interface 966 connects the imaging device 960 with a printer when printing an image, for example. Moreover, a drive is connected to the external interface 966 as needed. A removable medium such as a magnetic disk or an optical disk is mounted to the drive, for example, so that a program read from the removable medium can be installed to the imaging device 960. The external interface 966 may also be configured as a network interface that is connected to a network such as a LAN or the Internet. That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mounted to the media drive 968 so that a non-transportable storage unit such as a built-in hard disk drive or an SSD (Solid State Drive) is configured, for example.

The control unit 970 includes a processor such as a CPU and a memory such as a RAM and a ROM. The memory stores a program executed by the CPU as well as program data. The program stored in the memory is read by the CPU at the start-up of the imaging device 960 and then executed. By executing the program, the CPU controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The image processing unit 964 in the imaging device 960 configured in the aforementioned manner has a function of the image encoding device 10 and the image decoding device 60 according to the aforementioned embodiment. Accordingly, for scalable video encoding and decoding of images by the imaging device 960, the encoding efficiency can be further enhanced by reusing quad-tree information based on an image correlation between layers.

### 6. SUMMARY

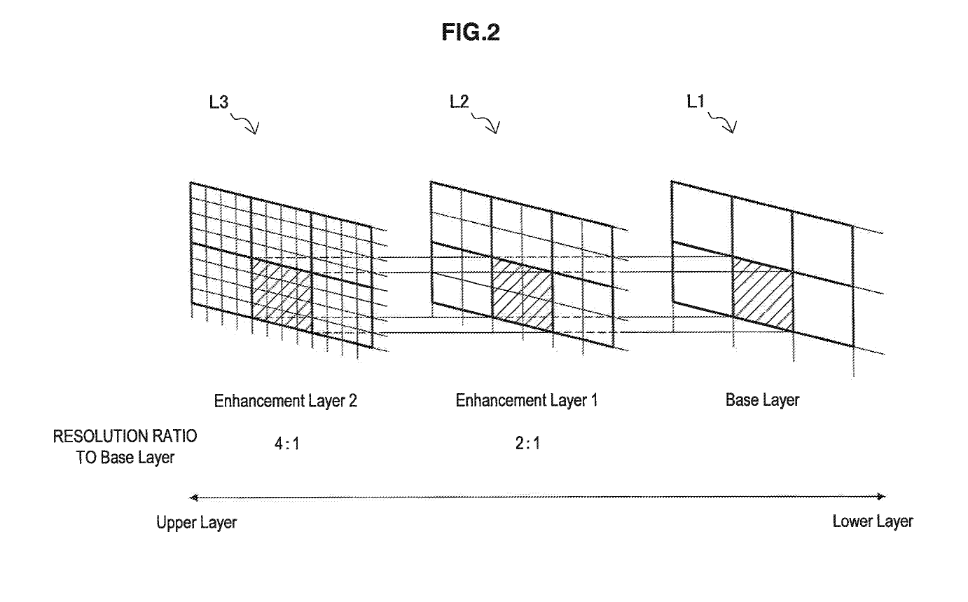

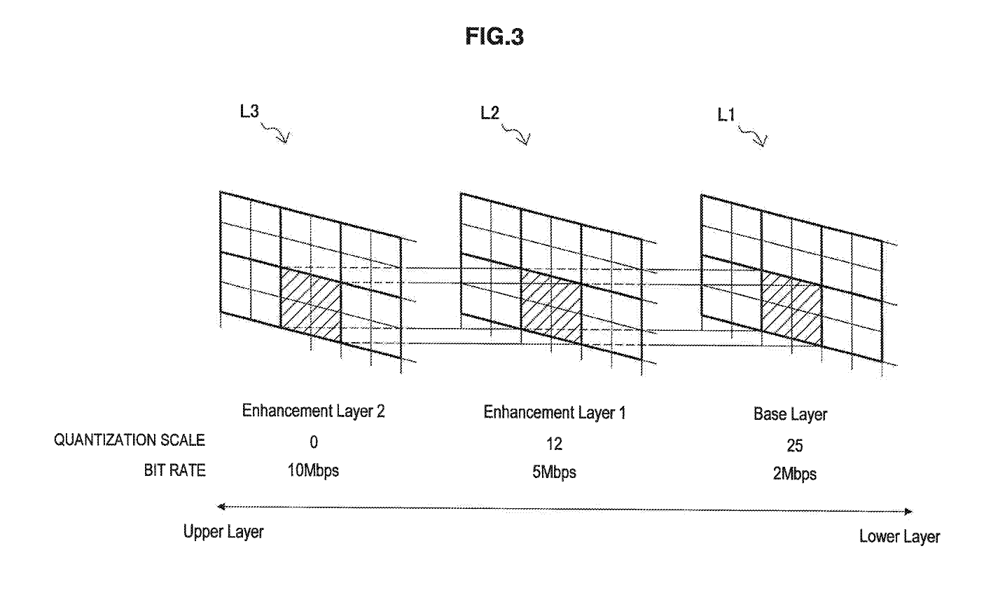

Heretofore, the image encoding device 10 and the image decoding device 60 according to an embodiment have been described in detail using FIGS. 1 to 26. According to the present embodiment, in scalable video encoding and decoding, a second quad-tree is set to the upper layer using quad-tree information identifying a first quad-tree set to the lower layer. Therefore, the necessity for the upper layer to encode quad-tree information representing the whole quad-tree structure of the upper layer is eliminated. That is, encoding of redundant quad-tree information over a plurality of layers is avoided and therefore, the encoding efficiency is enhanced.

Also according to the present embodiment, split information indicating whether to further divide the first quad-tree in the second quad-tree can be encoded for the upper layer. Thus, the quad-tree structure can further be divided in the upper layer, instead of adopting the same quad-tree structure as that of the lower layer. Therefore, in the upper layer, processes like the encoding and decoding, intra/inter prediction, orthogonal transform and inverse orthogonal transform, adaptive offset (AO), and adaptive loop filter (ALF) can be performed in smaller processing units. As a result, a fine image can be reproduced more correctly in the upper layer.

The quad-tree may be a quad-tree for a block-based adaptive loop filter process. According to the present embodiment, while quad-tree information is reused for an adaptive loop filter process, different filter coefficients between layers are calculated and transmitted. Therefore, even if quad-tree information is reused, sufficient performance is secured for the adaptive loop filter applied to the upper layer.

The quad-tree may also be a quad-tree for a block-based adaptive offset process. According to the present embodiment, while quad-tree information is reused for an adaptive offset process, different offset information between layers is calculated and transmitted. Therefore, even if quad-tree information is reused, sufficient performance is secured for the adaptive offset process applied to the upper layer.

The quad-tree may also be a quad-tree for CU. In HEVC, CUs arranged in a quad-tree shape become basic processing units of encoding and decoding of an image and thus, the amount of code can significantly be reduced by reusing quad-tree information for CU between layers. In addition, the amount of code can further be reduced by reusing the arrangement of PU in each CU and/or the arrangement of TU between layers. On the other hand, if the arrangement of PU in each CU is encoded layer by layer, the arrangement of PU is optimized for each layer and thus, the accuracy of prediction can be enhanced. Similarly, if the arrangement of TU in each PU is encoded layer by layer, the arrangement of TU is optimized for each layer and thus, noise caused by an orthogonal transform can be suppressed.

The mechanism of reusing quad-tree information according to the present embodiment can be applied to various types of scalable video coding technology such as space scalability, SNR scalability, bit depth scalability, and chroma format scalability. When spatial resolutions are different between layers, the reuse of quad-tree information can easily be realized by, for example, enlarging the LCU size or the maximum partition size in accordance with the ratio of spatial resolutions.

Mainly described herein is the example where the various pieces of header information such as quad-tree information, split information, offset information, and filter coefficient information are multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the 25 information may be transmitted on a different transmission path from the image (or the bit stream). The information may also be recorded in a different recording medium (or a different recording area in the same recording medium) from the image (or the bit stream). Furthermore, the information and the 30 image (or the hit stream) may be associated with each other by an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the an may find various alternations and modifications within the scope of the appended claims, and it should be understood that they will naturally come under the technical scope of the present disclosure.

Additionally, the present technology may also be configured as below.

(1)

An image processing apparatus including:

a decoding section that decodes quad-tree information identifying a first quad-tree set to a first layer of a scalable-video-decoded image containing the first layer and a second layer higher than the first layer; and

a setting section that sets a second quad-tree to the second layer using the quad-tree information decoded by the decoding section.

(2)

The image processing apparatus according to (1),

wherein the decoding section decodes split information indicating whether to further divide the first quad-tree, and

wherein the setting section sets the second quad-tree by further dividing a quad-tree formed by using the quad-tree information according to the split information.

(3)

The image processing apparatus according to (1) or (2), further including;

a filtering section that performs an adaptive loop filter process for each partition contained in the second quad-tree set by the setting section.

(4)

The image processing apparatus according to (3),

wherein the decoding section further decodes a filter coefficient of each of the partitions for the adaptive loop filter process of the second layer, and

wherein the filtering section performs the adaptive loop filter process by using the filter coefficient.

(5)

The image processing apparatus according to (1) or (2), further including:

an offset processing section that performs an adaptive offset process for each partition contained in the second quad-tree set by the setting section.

(6)

The image processing apparatus according to (5),

wherein the decoding section further decodes offset information for the adaptive offset process of the second layer, and

wherein the offset processing section performs the adaptive offset process by using the offset information.

(7)

The image processing apparatus according to (1) or (2),

wherein the second quad-tree is a quad-tree for a CU (Coding Unit), and

wherein the decoding section decodes image data of the second layer for each CU contained in the second quad-tree.

(8)

The image processing apparatus according to (7), wherein the setting section further sets one or more PUs (Prediction Units) for each of the CUs contained in the second quad-tree using PU setting information to set the one or more PUs to each of the CUs.

(9)

The image processing apparatus according to (8), wherein the PU setting information is information decoded to set the PU to the first layer.

(10)

The image processing apparatus according to (8), wherein the PU setting information is information decoded to set the PU to the second layer.

(11)

The image processing apparatus according to (8), wherein the setting section further sets one or more TUs (Transform Units) that are one level up for each of the PUs in the CU contained in the second quad-tree using TU setting information to set the TUs to each of the PUs.

(12)

The image processing apparatus according to (11), wherein the TU setting information is information decoded to set the TU to the first layer.

(13)

The image processing apparatus according to (11), wherein the TU setting information is information decoded to set the TU to the second layer.

(14)

The image processing apparatus according to any one of (7) to (13), wherein the setting section enlarges an LCU (Largest Coding Unit) size in the first layer based on a ratio of spatial resolutions between the first layer and the second layer and sets the second quad-tree to the second layer based on the enlarged LCU size.

(15)

The image processing apparatus according to any one of (1) to (13), wherein the first layer and the second layer are layers having mutually different spatial resolutions.

(16)

The image processing apparatus according to any one of (1) to (13), wherein the first layer and the second layer are layers having mutually different noise ratios.

(17)

The image processing apparatus according to any one of (1) to (13), wherein the first layer and the second layer are layers having mutually different bit depths.

(18)

An image processing method including:

decoding quad-tree information identifying a first quad-tree set to a first layer of a scalable-video-decoded image containing the first layer and a second layer higher than the first layer; and

setting a second quad-tree to the second layer using the decoded quad-tree information.

(19)

An image processing apparatus including:

an encoding section that encodes quad-tree information identifying a first quad-tree set to a first layer of a scalable-video-encoded image containing the first layer and a second layer higher than the first layer, the quad-tree information being used to set a second quad-tree to the second layer.

(20)

An image processing method including:

encoding quad-tree information identifying a first quad-tree set to a first layer of a scalable-video-encoded image containing the first layer and a second layer higher than the first layer, the quad-tree information being used to set a second quad-tree to the second layer.

### REFERENCE SIGNS LIST

10 image encoding device (image processing apparatus)
16 encoding section
60 image decoding device (image processing apparatus)
62 decoding section
212, 214, 216, 220, 230 setting section
224 offset processing section
234 filtering section

1. An image processing apparatus comprising:
a decoding section that decodes quad-tree information identifying a first quad-tree set to a first layer of a scalable-video-decoded image containing the first layer and a second layer higher than the first layer; and
a setting section that sets a second quad-tree to the second layer using the quad-tree information decoded by the decoding section.

2. The image processing apparatus according to claim 1,
wherein the decoding section decodes split information indicating whether to further divide the first quad-tree, and
wherein the setting section sets the second quad-tree by further dividing a quad-tree formed by using the quad-tree information according to the split information.

3. The image processing apparatus according to claim 1, further comprising:
a filtering section that performs an adaptive loop filter process for each partition contained in the second quad-tree set by the setting section.

4. The image processing apparatus according to claim 3,
wherein the decoding section further decodes a filter coefficient of each of the partitions for the adaptive loop filter process of the second layer, and
wherein the filtering section performs the adaptive loop filter process by using the filter coefficient.

5. The image processing apparatus according to claim 1, further comprising:
an offset processing section that performs an adaptive offset process for each partition contained in the second quad-tree set by the setting section.

6. The image processing apparatus according to claim 5,
wherein the decoding section further decodes offset information for the adaptive offset process of the second layer, and
wherein the offset processing section performs the adaptive offset process by using the offset information.

7. The image processing apparatus according to claim 1,
wherein the second quad-tree is a quad-tree for a CU (Coding Unit), and
wherein the decoding section decodes image data of the second layer for each CU contained in the second quad-tree.

8. The image processing apparatus according to claim 7, wherein the setting section further sets one or more PUs (Prediction Units) for each of the CUs contained in the second quad-tree using PU setting information to set the one or more PUs to each of the CUs.

9. The image processing apparatus according to claim 8, wherein the PU setting information is information decoded to set the PU to the first layer.

10. The image processing apparatus according to claim 8, wherein the PU setting information is information decoded to set the PU to the second layer.

11. The image processing apparatus according to claim 8, wherein the setting section further sets one or more TUs (Transform Units) that are one level up for each of the PUs in the CU contained in the second quad-tree using TU setting information to set the TUs to each of the PUs.

12. The image processing apparatus according to claim 11, wherein the TU setting information is information decoded to set the TU to the first layer.

13. The image processing apparatus according to claim 11, wherein the TU setting information is information decoded to set the TU to the second layer.

14. The image processing apparatus according to claim 7, wherein the setting section enlarges an LCU (Largest Coding Unit) size in the first layer based on a ratio of spatial resolutions between the first layer and the second layer and sets the second quad-tree to the second layer based on the enlarged LCU size.

15. The image processing apparatus according to claim 1, wherein the first layer and the second layer are layers having mutually different spatial resolutions.

16. The image processing apparatus according to claim 1, wherein the first layer and the second layer are layers having mutually different noise ratios.

17. The image processing apparatus according to claim 1, wherein the first layer and the second layer are layers having mutually different bit depths.

18. An image processing method comprising:
decoding quad-tree information identifying a first quad-tree set to a first layer of a scalable-video-decoded image containing the first layer and a second layer higher than the first layer; and
setting a second quad-tree to the second layer using the decoded quad-tree information.

19. An image processing apparatus comprising:
an encoding section that encodes quad-tree information identifying a first quad-tree set to a first layer of a scalable-video-encoded image containing the first layer and a second layer higher than the first layer, the quad-tree information being used to set a second quad-tree to the second layer.

20. An image processing method comprising:
encoding quad-tree information identifying a first quad-tree set to a first layer of a scalable-video-encoded image containing the first layer and a second layer higher than the first layer, the quad-tree information being used to set a second quad-tree to the second layer.
